(19) United States
(12) Patent Application Publication
(10) Pub. No.: US 2026/0205196 A1
(43) Pub. Date: Jul. 16, 2026

(54) OPTICAL WIRELESS DATA COMMUNICATION

(71) Applicant: The Regents of the University of Michigan, Ann Arbor, MI (US)

(72) Inventors: Jethro REIMANN, Dearborn, MI (US); Aaron BRZOZOWSKI, Ann Arbor, MI (US); Michael PUTTY, Grosse Pointe Woods, MI (US); Sridhar LAKSHMANAN, Belleville, MI (US)

(21) Appl. No.: 19/450,351

(22) Filed: Jan. 15, 2026

Related U.S. Application Data
(60) Provisional application No. 63/745,783, filed on Jan. 15, 2025.

(51) Int. Cl. H04B 10/116

(52) U.S. Cl. CPC H04B 10/116

(57) ABSTRACT

A light communication system and a device incorporating components of a light communication system are provided. The light communication system includes: a transmitter configured to transmit light; and a receiver configured to determine data encoded in the light transmitted by the transmitter. The receiver includes: a light sensor for sensing the light transmitted by the transmitter; analog circuitry configured to generate a conditioned analog signal based on a light signal that is output from the light sensor; and a digital signal processing device configured to recover a clock of the light transmitted by the transmitter by processing the conditioned analog signal and to decode the data encoded in the light using the clock.

### TECHNICAL FIELD

This invention relates to devices, systems, and methods for establishing and communicating across an ad hoc, light-based data network, and to a physical layer communication platform and protocol for the network.

### BACKGROUND

Optical or light communication systems, in which light is modulated to encode data or information for communication between light communication nodes, are useful for various applications, such as for establishing ad hoc networks among peers; for example, in one vehicular application, a visible light communication (VLC) system may be used for vehicle-to-vehicle (V2V) communications, as described in U.S. Pat. No. 11,245,469. However, such systems may involve or rely on extrinsic synchronization to synchronize the receiver with the transmitter so that the data encoded may properly be decoded. Such extrinsic synchronization refers to a synchronization process where the receiver is synchronized with the transmitter through use of a communications besides (and different from) the light communication system having the receiver to be synchronized. For example, extrinsic synchronization may involve informing the receiver of a data or clock rate of the input stream to be transmitted through use of a cellular network or dedicated short range communications (DSRCs). It has been discovered that there is needed a system and method for enabling intrinsic synchronization for ad hoc light communication networks—i.e., synchronization for ad hoc light communication networks that does not rely on either external communications, such as those using DSRCs or cellular communications, or on providing configuration to the vehicle during manufacture, such as by setting all clock rates of light communication nodes to be the same.

U.S. Pat. No. 11,245,469 teaches a vehicle line-of-sight optical communication system for use in ad hoc networks formed with a vehicle during traveling of the vehicle along a roadway. As discussed therein, V2V and vehicle-to-infrastructure (V2I) networks provide the capability to significantly reduce vehicular collisions by allowing vehicles to exchange messages with other vehicles, such as “changing lanes,” “braking hard,” “ice patch,” etc. Active and passive sensor-based vehicle object detection systems that do not involve V2V and V2I communication rely on the interpretation of signals to determine the behavior of nearby vehicles and other objects. The signals could be corrupted or jammed leading to wrong interpretation. Sensors can also fail leading to lost capability. A V2V network, on the other hand, relies on explicit information exchanged between vehicles in the form of data packets. These packets, if received without error, provide precise unambiguous information about the current status (e.g., position, speed, and heading) and intention (e.g., changing lanes, braking hard, making right turn) from nearby vehicles. This information may be fused with information from existing sensors (e.g., cameras, radars, lidars) to improve driving.

In realistic traffic scenarios (e.g., major roadways with heavy traffic) the number of vehicles, the speeds at which they are moving, and the continually changing position and heading relative to each other makes achieving a low latency, reliable V2V and/or V2I network very challenging.

V2V networks that rely on radio frequency (RF) communications, such as those using DSRCs, are widely envisioned to address this issue. However, these RF networks have inherent disadvantages due to the propagation characteristic of RF signals. The RF signals tend to propagate in patterns that are omnidirectional and in a plane. The result is that many more vehicles than those desired would receive an RF signal transmitted from a host vehicle. Thus, a network architecture based on DSRC may require additional processing and hardware overhead to determine which vehicles form a subnet, manage the orthogonal channel assignments (e.g., time, frequency, coding, and space) to those subnets, and then route packets between the vehicles in the subnet. Moreover, due to the continually changing position and orientation of vehicles relative to each other, these network must be capable of performing these tasks very quickly.

In some implementations, synchronization of a transmitter, such as one or more light sources, and a receiver may be carried out using external communications, such as Wi-Fi™ Bluetooth™, or other DSRC. Nonetheless, as mentioned above, it has been discovered that there is a need for a system and method for enabling intrinsic synchronization for ad hoc light communication networks—i.e., synchronization for ad hoc light communication networks that does not rely on external communications, such as any of those DSRCs described above, or through constraining the system to predefined properties or parameters.

To this end, Patent Application Publication No. US2023/0065439A1 discloses improvements in VLC technology that is suitable for use in for V2V and V2I ad hoc networks. This includes the use of adaptive filtering and automatic gain control to improve signal-to-noise ratio and reduce error rate, while providing a suitable bandwidth for V2V and V2I communication.

US Patent Application Publication No. US2023/0308254A1 discloses further improvements in line-of-sight optical communication networks by providing a system and method for intrinsic receiver synchronization with the transmitting source that eliminates the need for external (out of band) synchronization.

### SUMMARY

In accordance with an aspect of the invention, there is provided a light communication system. The light communication system includes: a transmitter configured to transmit light; and a receiver configured to determine data encoded in the light transmitted by the transmitter. The receiver includes: a light sensor for sensing the light transmitted by the transmitter; transimpedance op-amp circuitry having a transimpedance op-amp integrator circuit and a transimpedance op-amp differentiator circuit; a gain control circuit; and a digital signal processing device configured to recover a clock of the incoming light and to decode the data encoded in the light using the clock.

According to various embodiments, the light communication system of the first aspect of the invention may further include any one of the following features or any technically-feasible combination of some or all of these features:
the light sensor is a photodiode;
the transimpedance op-amp circuitry and the gain control circuit are a part of analog circuitry that generates a conditioned analog signal based on a light signal that is output from the light sensor;
the transimpedance op-amp integrator circuit is configured to generate a transimpedance integrated output signal by amplification of the sensor signal;
the transimpedance op-amp differentiator circuit is configured to generate a bandpass-filtered signal based on bandpass filtering of the transimpedance integrated output signal;
the gain control circuitry is configured to generate an analog gain control signal adjusting gain of an analog signal output by the transimpedance op-amp integrator circuit;
the gain control circuitry includes a non-inverting automatic op-amp circuit having a non-inverting op-amp for generating the analog gain control signal;
the digital signal processing device is a field programmable gate array (FPGA) or an application specific integrated circuit (ASIC);
the digital signal processing device includes an analog-to-digital converter (ADC) for converting an analog signal output by the gain control circuit into a digital signal;
the digital signal processing device includes an automatic gain control (AGC) module configured to generate a digital gain control signal based on sampled data sampled based on an analog signal output by the gain control circuit;
the digital signal processing device includes a clock data recovery (CDR) module for recovering a clock of the light transmitted by the transmitter and for decoding data encoded within the light using the clock;
the CDR module includes a clock recovery (CR) module and a data decoder module;
the CR module is configured to recovering the clock of the light transmitted by the transmitter;
the data decoder module is configured to decode the data encoded within the light using the clock;
the CDR module uses a finite-state machine (FSM) as a part of decoding the data encoded within the light using the clock;
the FSM is configured to implement an error correcting procedure using Reed-Soloman error correction or other error correction framework;
further comprising a microphone configured to capture audio at a first device in communication with the transmitter; and/or
the light transmitted by the transmitter includes encoded data representing the audio or text derived from the audio captured by the microphone.

In accordance with a second aspect of the invention, there is provided a light communication system. The light communication system includes: a transmitter configured to transmit light; and a receiver configured to determine data encoded in the light transmitted by the transmitter. The receiver includes: a light sensor for sensing the light transmitted by the transmitter; analog circuitry configured to generate a conditioned analog signal based on a light signal that is output from the light sensor, wherein the conditioned analog signal is generated by conditioning the light signal through transimpedance amplification; and a digital signal processing device configured to recover a clock of the light transmitted by the transmitter by processing the conditioned analog signal and to decode the data encoded in the light using the clock.

According to various embodiments, the light communication system of the second aspect of the invention may further include any one or more of those features discussed above in connection with the first aspect of the invention and/or any of the following features or any technically-feasible combination of some or all of these features:
the conditioned analog signal is generated by conditioning the light signal through bandpass filtering;
a transimpedance op-amp differentiator circuit is used for performing the bandpass filtering through generating a bandpass-filtered signal based on a transimpedance integrated output signal output from a transimpedance op-amp integrator circuit;
the analog circuitry includes a gain control circuit for generating an analog gain control signal; and/or
the digital signal processing device includes an automatic gain control (AGC) module for generating a digital gain control signal based on the analog gain control signal.

In accordance with a third aspect of the invention, there is provided a light communication system. The light communication system includes: a transmitter configured to transmit light; and a receiver configured to determine data encoded in the light transmitted by the transmitter. The receiver includes: a light sensor for sensing the light transmitted by the transmitter; analog circuitry configured to generate a conditioned analog signal based on a light signal that is output from the light sensor; and a digital signal processing device having an automatic gain control (AGC) module and a clock recovery module, wherein the AGC module is configured to generate a gain-controlled digital signal, wherein the clock recovery module is configured to recover a clock of the incoming light, and wherein the clock of the incoming signal is used to decode the data encoded in the light.

According to various embodiments, the light communication system of the third aspect of the invention may further include any one or more of those features discussed above in connection with the first or the second aspect of the invention. According to an embodiment, the light communication system of the third aspect of the invention is characterized by the analog circuitry including transimpedance op-amp circuitry for conditioning the light signal through transimpedance amplification and bandpass filtering.

According to various embodiments, the light communication system of the first aspect of the invention may further include any one or more of those features discussed above in connection with the second or the third aspect of the invention. Also, according to various embodiments, the light communication system of the second aspect of the invention may further include any one or more of those features discussed above in connection with the third aspect of the invention.

### BRIEF DESCRIPTION OF THE DRAWINGS

Preferred exemplary embodiments will hereinafter be described in conjunction with the appended drawings, wherein like designations denote like elements, and wherein:

FIG. 1 is a block diagram depicting a light communication system having a pair of electronic devices that provide one way data communication, according to one embodiment;

FIG. 2 is a block diagram depicting a light communication system similar to the light communication system of FIG. 1, except that the light communication system of FIG. 2 utilizes a pair of transceivers (transmitter+receiver) to enable bi-directional (duplex) data transfer between two electronic devices, according to one embodiment;

FIG. 3 illustrates one specific example application of the use of the light communication systems of FIG. 1 and FIG. 2 for V2V and V2I communication, according to one embodiment;

FIG. 4 illustrates a host vehicle, including vehicle electronics of the host vehicle, that is used as a part of the specific example application of FIG. 3, according to one embodiment;

FIG. 5 illustrates another example vehicle application of the light communication systems of FIG. 1 and FIG. 2 in which a vehicle arriving at a facility has integrated into its vehicle electronics a transmitter and I/O circuit that connects the transmitter to a vehicle bus, according to one embodiment;

FIG. 6 is a block diagram depicting components of a transmitter that may be used in the light communications systems of FIGS. 1 and 2, according to one embodiment;

FIG. 7 illustrates circuitry used for a power supply circuit of the transmitter of FIG. 6, according to one embodiment;

FIG. 8 illustrates circuitry used for a microcontroller decoupling circuit of the transmitter of FIG. 6, according to one embodiment;

FIG. 9 depicts an exemplary microcontroller that may be used for the transmitter of FIG. 6, according to one embodiment;

FIG. 10 illustrates circuitry used for microcontroller programming/debugging components that may be used with or for the transmitter of FIG. 6, according to one embodiment;

FIG. 11 illustrates circuitry used for a light source driver circuit of the transmitter of FIG. 6, according to one embodiment;

FIG. 12 is a block diagram depicting components of a receiver that may be used in the light communications systems of FIGS. 1 and 2, according to one embodiment;

FIG. 13 is a block diagram depicting components of a receiver (such as, for example, the receiver of FIG. 12) that may be used in the light communications systems of FIGS. 1 and 2, according to one embodiment;

FIG. 14 illustrates circuitry used for a power supply circuit of the receiver of FIG. 12, according to one embodiment;

FIG. 15 illustrates various connections used in implementing a receiver (such as, for example, the receiver of FIG. 12) on a printed circuit board (PCB) as well as a set of LEDs operated by a field programmable gate array (FPGA) for monitoring/test, according to one embodiment

FIG. 16 illustrates circuits used for transimpedance op-amp circuitry of the receiver of FIG. 12, according to one embodiment;

FIG. 17 illustrates circuitry used for a gain control circuit of the receiver of FIG. 12, according to one embodiment;

FIG. 18 illustrates circuitry used for a voltage divider circuit of the receiver of FIG. 12, according to one embodiment;

FIG. 19 illustrates circuitry used for a voltage follower circuit of the receiver of FIG. 12, according to one embodiment;

FIG. 20 depicts a Bode diagram with two graphs illustrating a bandpass filter with the frequency response of the transimpedance op-amp circuitry of FIG. 16, according to one embodiment;

FIG. 21 illustrates aspects of a transmission encoding scheme (protocol) used by the transmitter and receiver, including a packet level diagram for Table 1, along with the Reed-Solomon bytes at the end of the packet, according to one embodiment;

FIG. 22 illustrates aspects of a transmission encoding scheme (protocol) used by the transmitter and receiver, including an exemplary structure of a single data byte, according to one embodiment;

FIG. 23 depicts a CMOD A7-35T development board for a programmed FPGA used to carry out the ADC and digital functions, according to one embodiment;

FIG. 24 depicts graphs showing sample waveforms from an automatic gain control (AGC) state machine, according to one embodiment;

FIG. 25 is a block diagram of a clock recovery (CR) module of the digital signal processing device of the receiver of FIG. 12, according to one embodiment;

FIG. 26 is a block diagram of a quadrature signal conditioning module and a signal multiplier of the CR module of FIG. 25, according to one embodiment;

FIG. 27 is a graph illustrating frequency response magnitude of a frequency error signal resulting from the quadrature signal conditioning module and the signal multiplier of FIGS. 25-26, according to one embodiment;

FIG. 28 is a block diagram of a proportional integral (PI) controller of the CR module of FIG. 25, according to one embodiment;

FIG. 29 is a block diagram of a portion of the CR module of FIG. 25 including a roll-over accumulator (sawtooth generator), according to one embodiment;

FIG. 30 is a unit circle and graph illustrating aspects of a direct digital synthesizer (DDS) used as a part of the CR module of FIG. 25, according to one embodiment;

FIG. 31 is a block diagram of a VHDL (Very High-Speed Integrated Circuit (VHSIC) Hardware Description Language) component used as a part of a Reed-Soloman State Machine for a clock data recovery (CDR) module of the receiver of FIG. 12, according to one embodiment;

FIG. 32 is an exemplary prototype implementation of a receiver and transmitter that may be used in the light communications systems of FIGS. 1 and 2, according to one embodiment;

FIG. 33 is another exemplary prototype implementation of a receiver and transmitter that may be used in the light communications systems of FIGS. 1 and 2, according to one embodiment;

FIG. 34 illustrates various commercially-available vehicle exterior lamp modules modified to include a transmitter that may be used in the light communications systems of FIGS. 1 and 2, according to one embodiment;

FIG. 35 is a block diagram depicting the light communication system of FIG. 1 and including an interface input device in communication with the transmitter and a HMI output device in communication with the receiver, according to one embodiment;

FIG. 36 is a block diagram depicting the light communication system of FIG. 2 and including an interface device in communication with each transceiver, according to one embodiment; and

FIG. 37 is a block diagram depicting a microphone-input light communication system, which may be used for the light communication systems of FIGS. 35 and 36, according to one embodiment.

### DETAILED DESCRIPTION

The technology discussed herein enables synchronization of communications between two electronic devices that are carried out using optical or light communications. This permits establishment of intrinsic synchronization in peer-to-peer ad hoc networks. Electronic devices having optical or light communication capabilities, such as line-of-sight optical communication capabilities, are each referred to herein as a light communication node and may include one or more transmitters for transmitting light in order to send data to another node and/or may include one or more receivers for receiving light in order to obtain data sent by another node. The “light” or “optical” communications discussed herein means not only visible light (e.g., for VLC), but also light invisible to the human eye that has a wavelength suitable for use in line-of-sight or reflective communication, including at least portions of the infrared (IR), visible, and ultraviolet (UV) light spectrums. The transmitter encodes or modulates the data using light at or according to a transmitter clock rate and transmits such encoded data as a data input stream, which is then received at the receiver. At least in some embodiments, in order to properly decode and/or interpret the data input stream so as to obtain the data that is being communicated by the transmitter, the receiver synchronizes a clock that matches that used by transmitter to encode the data input stream. The synchronized clock is then used to decode the data input stream so as to obtain the data.

According to embodiments, a light communication system is provided and includes: a transmitter configured to transmit light; and a receiver configured to receive the light transmitted by the transmitter and to determine data encoded in the received light. In embodiments, the receiver includes: a light sensor, such as, for example, a photodiode; analog circuitry configured to generate a conditioned analog signal based on a light signal output from the light sensor; and a digital signal processing device configured to recover a clock of the received light and to decode the data encoded in the received light using the recovered clock. According to embodiments, the analog circuitry includes: transimpedance op-amp circuitry having a transimpedance op-amp integrator circuit and/or a transimpedance op-amp differentiator circuit; and/or a gain control circuit. Also, according to embodiments, the digital signal processing device is a field programmable gate array (FPGA) or application-specific integrated circuit (ASIC). Further, in embodiments, the digital signal processing device includes an automatic gain control (AGC) module and a clock recovery module, where the AGC module is configured to generate a gain-controlled digital signal and where the clock recovery module is configured to recover the clock of the received light. In embodiments, the digital signal processing device includes a data decoder module for decoding the data within a sampled data signal that is generated based on an output from the analog circuitry and the clock recovered by the clock recovery module.

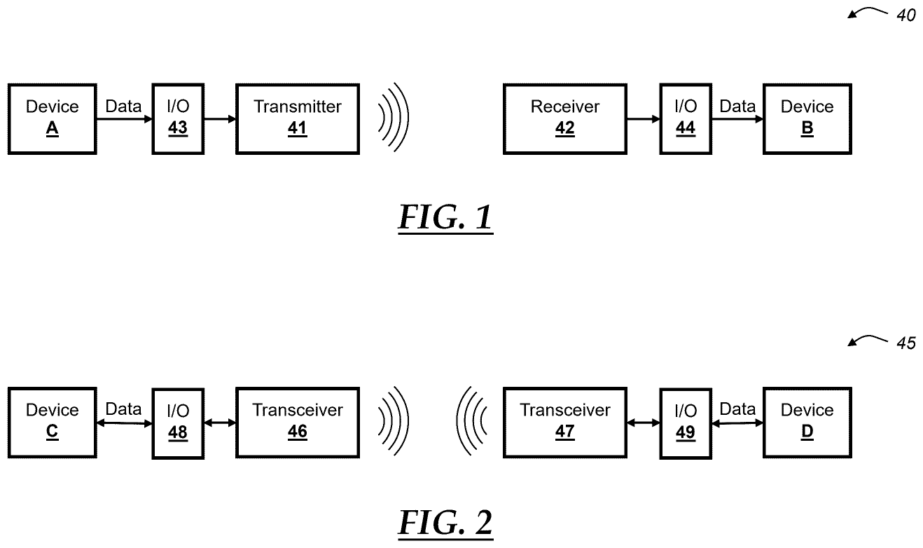

FIG. 1 depicts a light communication system 40 having a pair of electronic devices A and B that provide one way data communication from Device A to Device B. This simplex communication is accomplished using a transmitter 41 electronically coupled with Device A, and a receiver 42 electronically coupled to Device B. The Devices A and B are coupled to their respective transmitter 41 and receiver 42 via input/output (I/O) circuits 43, 44, respectively. These I/O circuits enable the interfacing of various types of electronic devices to various types of light transmitters, receivers, and transceivers, in many cases allowing for the use of pre-existing electronic devices without the need for significant, if any, circuit modifications of those devices.

Device A, transmitter 41, and I/O 43 together comprise a light communication node and the electronics for each can be integrated together into a single physical device or be interconnectable, e.g., by wires. Similarly, this can be done for Device B, receiver 42, and I/O 44. Transmitter 41 and receiver 42 have a design, construction, and operation that will be described below, but can include one or more of the features disclosed in the aforementioned U.S. Pat. No. 11,245,469 and U.S. Patent Application Publication Nos. US2023/0065439A1 and US2023/0308254A1, the entire disclosures of which are hereby incorporated by reference.

FIG. 2 discloses a light communication system 45 similar to the system 40 of FIG. 1, except that light communication system 45 utilizes a pair of transceivers (transmitter+receiver) 46 and 47 to enable bi-directional (duplex) data transfer between two electronic devices C and D. As in FIG. 1, the Devices C and D are electronically coupled to their respective transceivers 46, 47 by I/O circuits 48 and 49, respectively. Transceivers 46 and 47 can be implemented by utilizing both a transmitter and a receiver, and this can be done either by providing a transmitter 41 and receiver 42 separately in each transceiver, or by integrating them together using a single circuit that provides all of the necessary analog and digital functions. Further, transceivers 46 and 47 can be identical transceivers or ones having different components or parameters, such as to utilize different clock rates or otherwise to permit rejection of unwanted received light modulations. As will become apparent to those skilled in the art, this use of different transmission attributes by different transmitters can be used by a receiver or transceiver to reject any received (e.g., reflected) light data transmissions originating from itself or from mixing of communications coming from multiple other devices.

Although the light used for communication can be inside or outside of the visible spectrum, many embodiments of the transmitter and receiver can use visible light, such as is used in visible light communication (VLC) systems. This allows for the use of existing device components such as the illumination-providing lights used for vehicle exterior illumination and other illuminating devices and applications. Except where otherwise described, the transmitters, receivers, and transceivers described utilize visible light to set up a VLC network, such that light communication systems 40 and 45 may also be referred to as VLC systems 40 and 45.

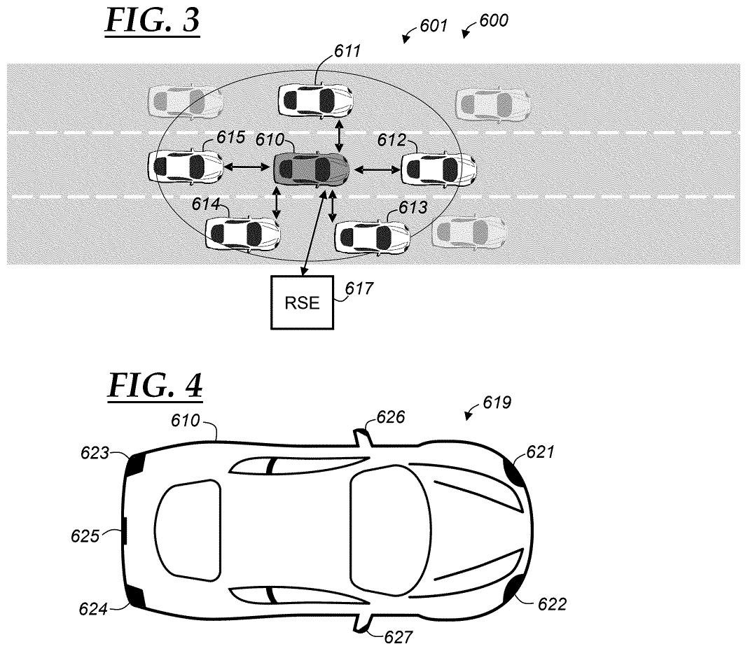

FIG. 3 provides one specific example application of the use of a VLC system for V2V and V2I communication. FIG. 3 illustrates a road segment with a plurality of vehicles each equipped with a VLC system 45 as will be described below. Also present is roadside equipment (RSE) that includes either a transmitter alone or a transmitter and receiver depending on the need for receipt of V2I data by the RSE from one or more of the vehicles. The roadside equipment (RSE) may be utilized to provide the nearby vehicles with basic safety messages (BSMs) and other data.

In particular, FIG. 3 depicts a vehicle communications system 600 that includes a first or host vehicle 610, a second vehicle 611, a third vehicle 612, a fourth vehicle 613, a fifth vehicle 614, a sixth vehicle 615, and roadside equipment (RSE) 617. Each of the vehicles 610-616 and the RSE 617 include a transceiver 46 or 47 and may thus be referred to as light communication nodes 612-617 that communicate with one another in an ad hoc light communication network 601.

FIG. 4 depicts the host vehicle 610, which is shown as including vehicle electronics 619 having a left headlight communication module 621, a right headlight communication module 622, a left taillight communication module 623, a right taillight communication module 624, a center taillight communication module 625, a left side mirror communication module 626, and a right side mirror communication module 627. Each of these light communication modules 621-627 includes a transceiver 46 or 47 for bidirectional light communications and is integrated into the vehicle electronics using an I/O circuit 48 or 49 which enables access to/from the transceiver from a vehicle network such as a controller area network (CAN) or other network bus on the vehicle. Moreover, it should be appreciated that, in other embodiments, the transceivers of the light communication modules 621-627 may be integrated into other components of the host vehicle 610 (instead of a headlight or other external vehicle light/lamp module) and/or may vary in configuration and number.

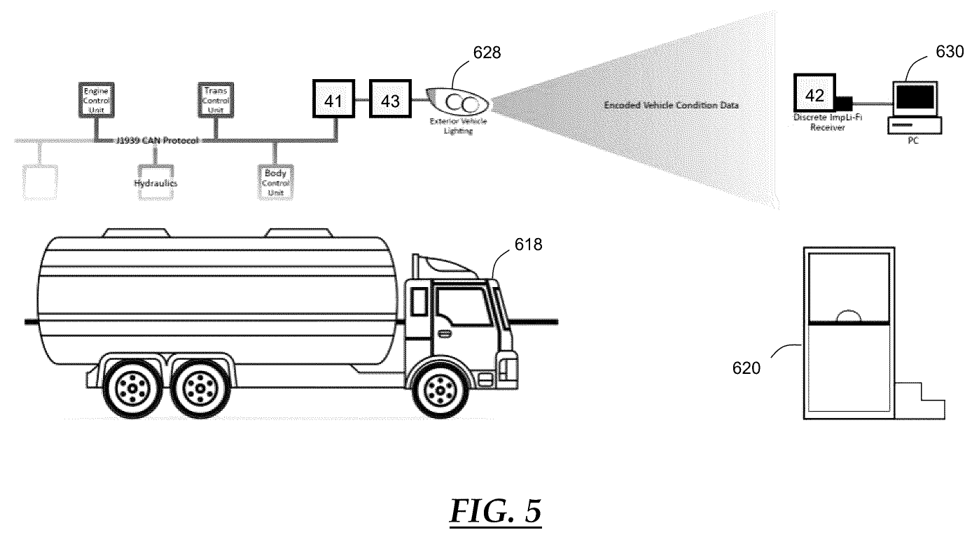

FIG. 5 depicts another example vehicle application of the VCL system in which a vehicle 618 arriving at a facility 620 has integrated into its vehicle electronics a transmitter 41 and I/O circuit 43 that connects the transmitter 41 to the vehicle bus, which in this example is a J1939 CAN bus. As is known, modern vehicles include a number of different electronic modules on the vehicle bus, such as an engine control unit (ECU), transmission control unit (TCU), hydraulic system sensors and control, and a body control module (BCM), all of which are shown in FIG. 5. With access to the CAN bus, the transmitter 41 can utilize its built in logic and/or programming to obtain various vehicle parameters (e.g., VIN, OBDII diagnostic codes, etc.) and communicate them to a receivers 42 at the facility 620. Those skilled in the art will know the construction, logic, programming, and protocols needed for this integration and use of the transmitter 41 with the vehicle bus. This allows for assistance with automatically identifying vehicle condition and is useful for maintenance and diagnostic purposes, such as via use of a computer 630 located either at the facility 620 or remotely.

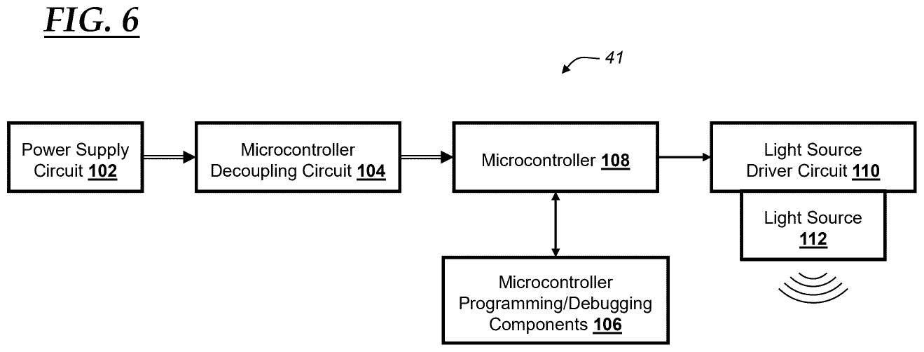

Turning now to FIGS. 6-11, the construction of the transmitter 41 will be described, and it will be appreciated that this same described embodiment can be used for the transmitter of transceivers 46 and/or 47.

The transmitter 41 includes a power supply circuit 102, a microcontroller decoupling circuit 104, microcontroller programming/debugging components 106, a microcontroller 108, a light source driver circuit 110, and a light source 112. In other embodiments, the transmitter 41 may include other components or may omit one or more components, such as, for example, one or more of components 102-106. In FIG. 6, in general, the double-line compounded arrows illustrate electric power and the single-line compounded arrows illustrate electronic signals.

In general, transmitter 41 utilizes a 32-bit microcontroller, such as an STM32F103 available from STMicroelectronics, along with a metal-oxide-semiconductor field-effect transistor (MOSFET) connected to drive a dedicated or existing lamp (or light emitting diode (LED)) in the Device A (e.g., vehicle 610 or 618). This can be done using the microcontroller's USART hardware to pulse the MOSFET for modulation of the light output. Components such as the 12V-to-5V DC voltage regulator, power MOSFET, pin headers, and 12V battery power cable connectors are through-hole. According to the present embodiment, the rest of the design utilizes surface-mount components.

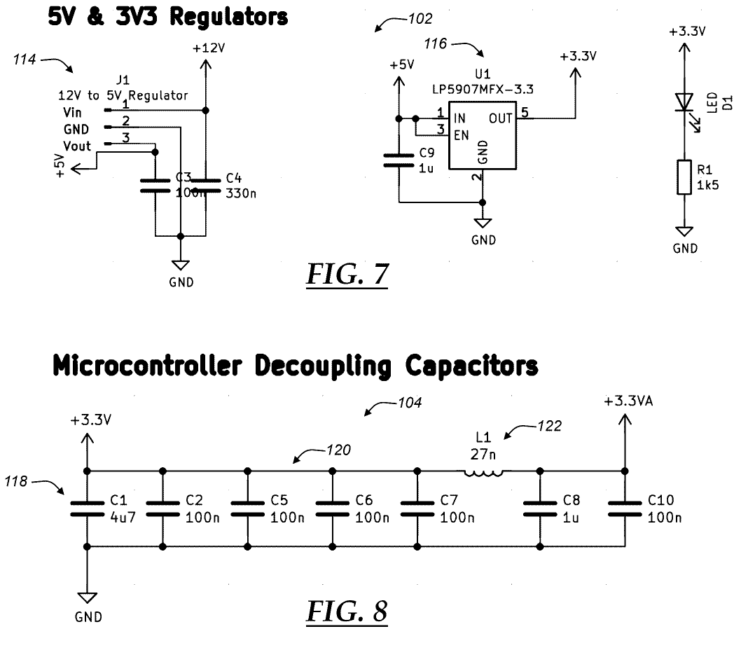

The power supply circuit 102 is connected to a battery, such as, for example, a 12V battery. The power supply circuit 102 is used for stepping down the voltage of the battery to a suitable voltage for the microcontroller 108. In the present embodiment, power for the transmitter components is generated from 12V battery voltage by the circuitry of FIG. 7 to provide 5V and 3.3V (3V3) supplies. A pair of shrouded blade-style battery connectors supply 12 VDC nominal and Ground connections to the board. The 12V input power is stepped down to 5V by an L7805 through-hole low-dropout (LDO) regulator 114, and this 5V is in turn stepped down to 3.3V by an LP5907 LDO regulator 116. A small indicator LED D1 confirms that 12V input is connected and both LDO regulators 114,116 are active.

The microcontroller decoupling circuit 104 is configured to apply power supply smoothing to the power supplied by the battery via the power supply circuit 102. In the present embodiment, the microcontroller decoupling circuit 104 includes a bulk decoupling capacitor 118 to filter out noise from the power supply circuit 102, individual decoupling capacitors 120 deployed at each digital voltage pin, and a choke 122 configured to impede high-frequency signals. In the present embodiment, FIG. 8 depicts the microcontroller decoupling circuit 104 with the bulk decoupling capacitor 118 being 4.7 μF and configured to filter out noise from the LDO regulators 114,116. The individual decoupling capacitors 120 of the present embodiment of FIG. 8 are individual 100 nF decoupling capacitors and are deployed at each digital voltage input pin. Furthermore, additional smoothing required for the analog voltage input can be achieved using the choke 122, which is 27 nH in the present embodiment of FIG. 8 and which is placed in series with parallel 1 μF and 100 nF capacitors. This extra power supply smoothing may be superfluous in this application as the microcontroller's analog hardware is not utilized and may be omitted in certain embodiments.

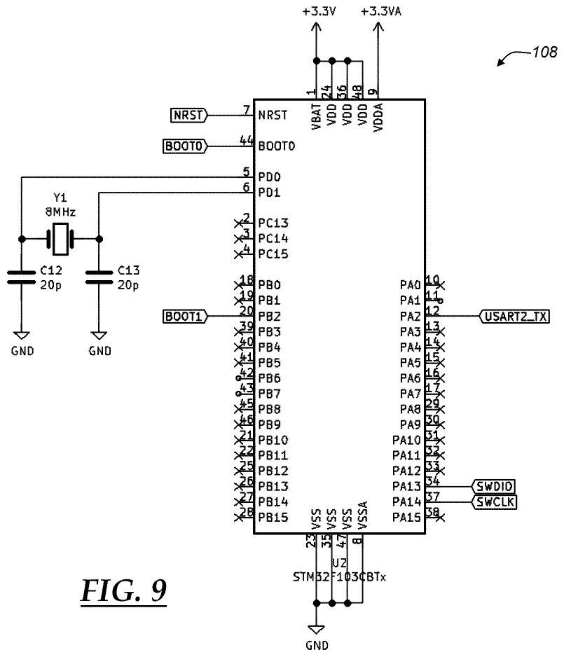

The microcontroller 108 is used for controlling the light source driver circuit 110 in order to cause the light source 112 to be driven according to data received at the microcontroller 108 from the Device A (or Device C or D). FIG. 9 depicts an embodiment of the microcontroller 108 in which the microcontroller 108 is a STM32F103 microcontroller. In embodiments, the microcontroller 108 has: timing pins [PD0. PD1] for connecting to a high-speed external crystal oscillator; Universal Synchronous/Asynchronous Receiver/Transmitter (USART) hardware; a light source driver pin for outputting signals driven by the USART hardware; and microcontroller programming/debugging pins for connecting to the programming/debugging components 106. According to the present embodiment, apart from power and ground connections, the only other pins required to be connected on the STM32F103 microcontroller in this application are:
PD0 and PD1, for the high-speed external crystal oscillator (Y1 in the diagram above)
PA2, for the USART hardware Tx output, which drives our light-modulating power MOSFET.
PA13 and PA14, for the Serial Wire Debug (SWD) Input/Output and Clock signals, respectively. SWD is used for both programming and debugging purposes.
NRST, BOOT0, and PB2 (BOOT1).

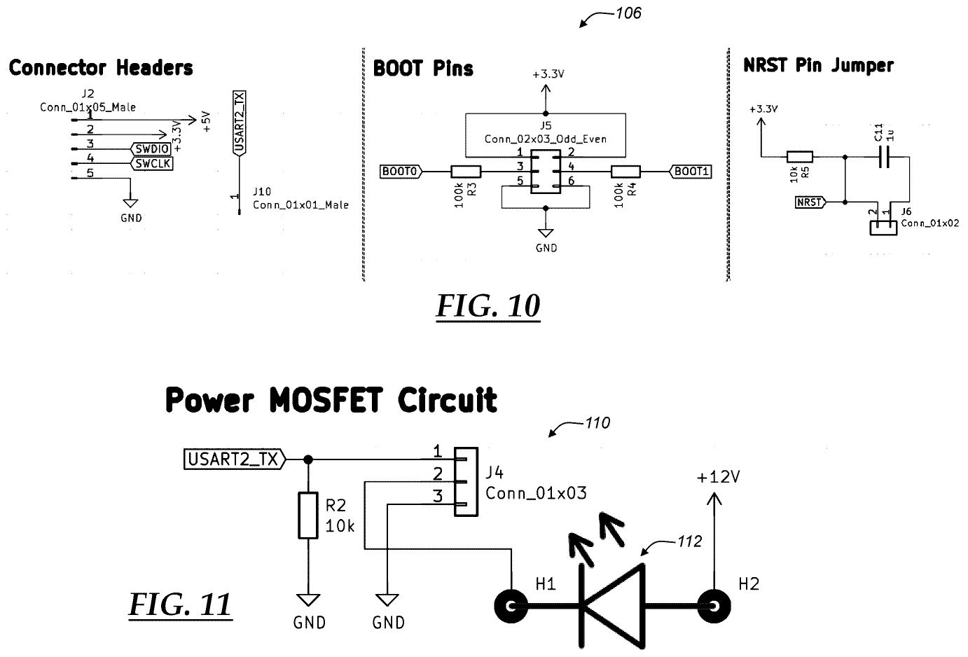

The microcontroller programming/debugging components 106 are used for programming and/or debugging the microcontroller 108. Referring to FIG. 10, Serial Wire Debug can be connected for programming and debugging the microcontroller through a set of five header pins (left figure), with 3.3V and 5V references provided over Universal Serial Bus (USB) from a debugging tool. The microcontroller boot mode can be selected prior to power-on by toggling the boot pins (middle figure) according to the guidance contained in STMicro Application Note 2606. Finally, a jumper connected to the reset pin NRST (right figure) allows the pin to be toggled for microcontroller unit (MCU) reset. A 1 μF capacitor helps debounce the NRST input.

The light source driver circuit 110, also referred to as the lamp driver circuit, is shown in FIG. 11. In the present embodiment, the light source driver circuit 110 uses through-hole N-channel power MOSFET (Onsemi/Fairchild FQP30N06L or equivalent) to on-off key the connected LED illumination source that provides the modulated light data used in communicating with the receiver 42. There is a pull-down resistor on the MCU USART Tx pin to ensure it does not float during MCU initialization. The USART Tx output acts on the MOSFET gate, switching the 12V supply to the LED (the light source 112 of the present embodiment).

These physical components of FIGS. 6-11 make up the transmitter using the communications protocol described below following a discussion of the receiver analog circuitry. The associated programming of the microcontroller of transmitter 41 to carry out the communications according to the described protocol will be apparent to those skilled in the art.

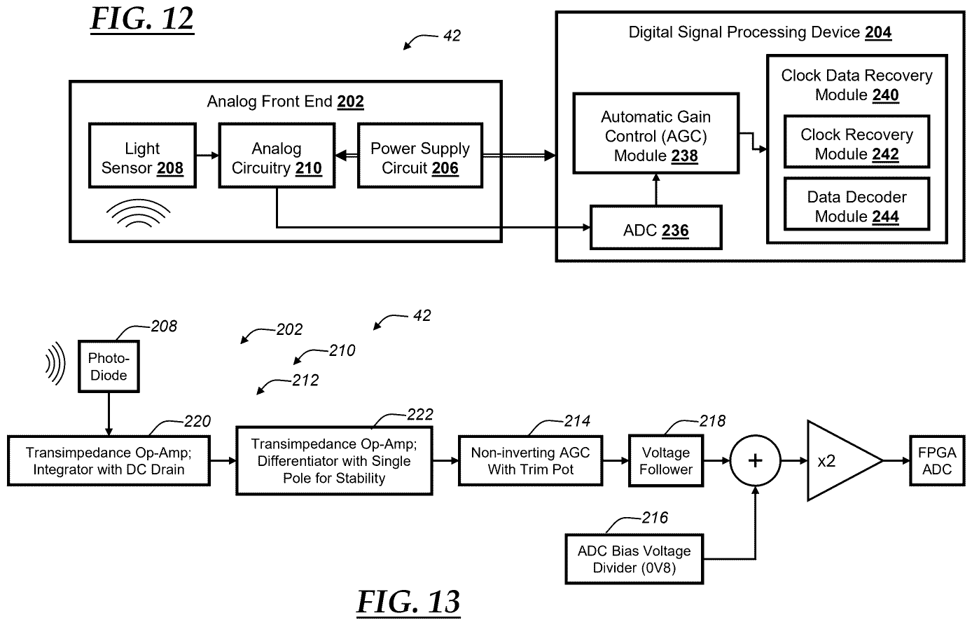

FIGS. 12-31 depict the construction and operation of the receiver 42, including both its analog front end 202 and its signal processing carried out by a digital signal processing device 204 (e.g., a field programmable gate array (FPGA), an application-specific integrated circuit (ASIC)) that implements the digital processing to determine clocking and recover data from the modulated light signal received from the transmitter 41. FIGS. 12-19 depict the analog front end 202, with FIG. 13 being a block diagrammatic view of the analog circuitry that filters and pre-processes the received light signal prior to its conversion to digital and processing by the digital signal processing device 204.

The analog front end 202 of the receiver 42 includes a power supply circuitry 206 for conditioning power provided to the other components of the receiver 42, a light sensor 208 depicted as a photodiode in the present embodiment, and analog circuitry 210. The light sensor 208 is configured to sense incoming light, such as the light transmitted by the transmitter 41, and to generate a sensor signal, which is a photodiode signal generated by the photodiode (light sensor 208) in the present embodiment. In the present embodiment, the analog circuitry 210 is configured to generate a conditioned analog signal based on the sensor signal and a photodiode reverse bias signal from photodiode reverse bias circuit.

In the present embodiment, the analog front end 202 includes the light sensor (photodiode) 208, a two-stage capacitive-feedback transimpedance operational amplifier topology, a gain stage, a clipping circuit, and voltage leveling to bring the signal into the voltage into the ADC's sampling threshold (0V to 3V3). Apart from that, there is a DC-DC railsplitter, which is fed +5 VDC and outputs −5 VDC to +5 VDC, granting 10 Vₚₑₐₖ₋ₜₒ₋ₚₑₐₖ for op-amp rails. This all culminates into the processed signal being fed into the ADC of a CMOD A7-35T breadboardable FPGA development board, which is also used to source power for the rest of the circuit via USB. This CMOD A7-35T utilizes the XC7A35T-1CPG236C SoC FPGA.

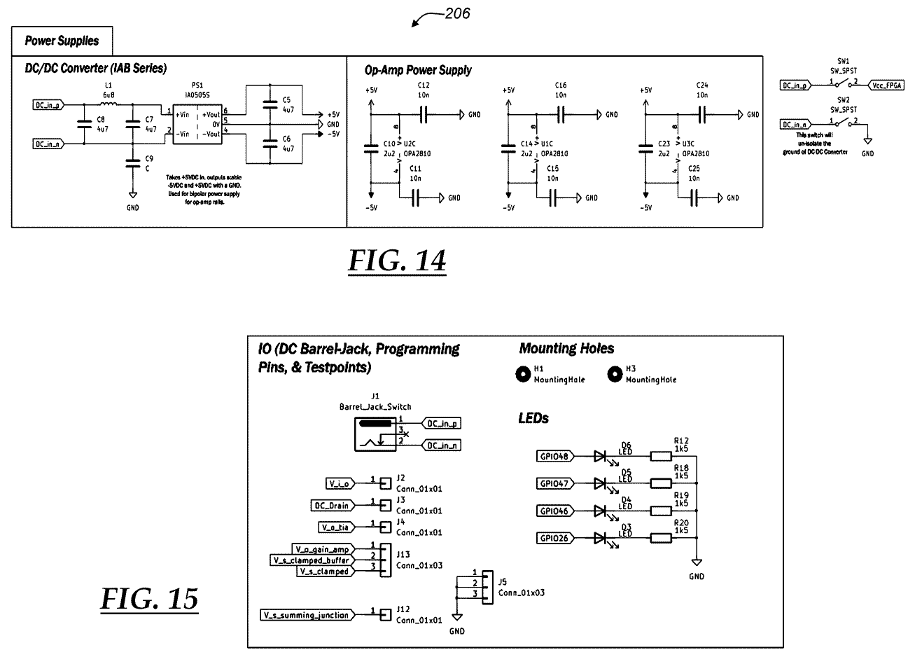

According to the present embodiment, the photodiode part number is the SFH 203 P, manufactured by AMS OSRAM, and there are three dual-channel op-amps, providing six op-amps in total. These are part number OPA2810IDGKR. The system of the present embodiment operates on 5 VDC input, which is sourced from the host computer's USB port via a 5V DC and GND pin on the FPGA daughter board. This is fed into a IAB0105D05 isolated DC-DC Converter, which outputs an isolated −5V DC, +5V DC, and GND. These power supply circuits of the power supply circuitry 206 are shown in FIG. 14. FIG. 15 depicts various connections used in implementing the receiver on a printed circuit board (PCB) as well as a set of LEDs operated by the FPGA for monitoring/test.

The receiver 42 is implemented on a CMOD A7-35T, which is an FPGA Development board with many built in peripherals for speedy prototyping and development, namely a 1 MSPS ADC. The rest of the PCB design consists of passive discrete components, namely SMT resistors and capacitors of various values.

In the preset embodiment, the analog circuitry 210 includes: transimpedance op-amp circuitry 212, gain control circuitry 214, an analog-to-digital converter (ADC) voltage divider circuit 216, and a voltage follower circuit 218.

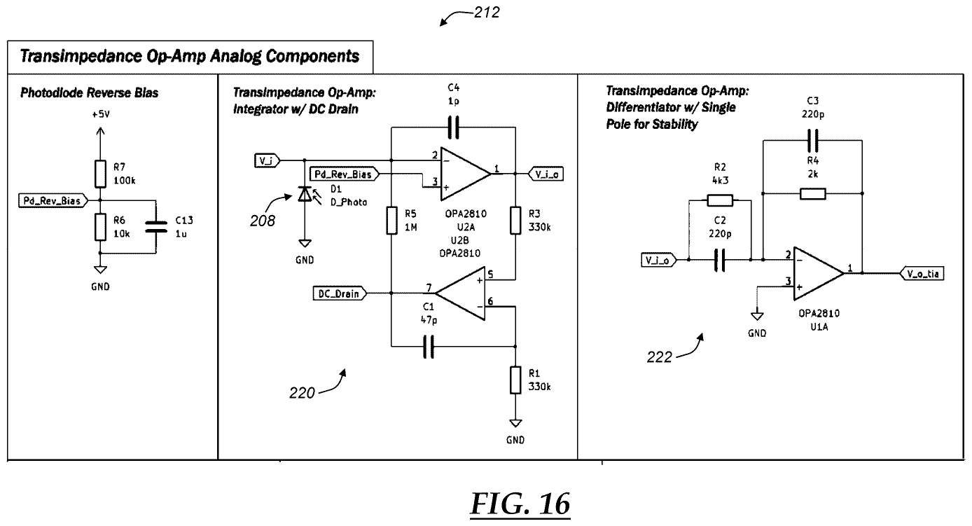

Referring to FIG. 16, the transimpedance op-amp circuitry 212 of the present embodiment is shown and includes: a transimpedance op-amp integrator circuit 220 for generating a transimpedance integrated output signal by amplification of the sensor signal and using the photodiode reverse bias signal; and a transimpedance op-amp differentiator circuit 222 for generating a bandpass-filtered signal based on bandpass filtering of the transimpedance integrated output signal.

In the present embodiment, the transimpedance op-amp circuitry 212 includes a filtered, voltage-divider reverse bias comparative voltage for the photodiode (Pd_Rev_Bias), as well as the integrator 220 with DC drain and the differentiator 222 with a single pole for stability. The photodiode 208 of the receiver 42 is shown connected to the inverting input of the first stage of the transimpedance op-amp circuitry 212. This transimpedance op-amp integrator circuit 220 is used to convert the current from the photodiode to a voltage signal, and is based a capacitive-feedback integrator with DC drain topology. This means that in lieu of a resistor (as is standard in transimpedance topologies) between the op-amp output and the inverting input pin of the op-amp, a capacitor is used for feedback. The DC-Drain component acts as a low-pass filter, which (at least in the present embodiment) is necessary for eliminating ambient light with low frequency change in intensity (e.g., sunlight, streetlights, etc.). The output of this transimpedance op-amp integrator circuit 220 is fed into a differentiator op-amp (of the transimpedance op-amp differentiator circuit 222), which extends the high frequency cut-off. The topology as a whole effectively acts as both a current-to-voltage converter, and a bandpass filter.

Given that this topology is composed of linear components (resistors, capacitors, and op-amps), and devoid of non-linear components (diodes and transistors), the system can be represented as a linear-time-invariant (LTI) system with a corresponding transfer function in the s-domain. For this circuit, the transfer function simplifies down to:

$$H ( s ) = \frac{{R}_{4}}{{R}_{2} {C}_{f}} [ \frac{( {C}_{2} {R}_{2} s + 1 )}{( {C}_{3} {R}_{4} {s}^{3} + ( \frac{{C}_{3} {R}_{4}}{{C}_{4} {R}_{5}} + 1 ) {s}^{2} + ( \frac{{C}_{3} {R}_{4}}{{C}_{1} {R}_{1} {C}_{4} {R}_{5}} + \frac{1}{{C}_{4} {R}_{5}} ) s + \frac{1}{{C}_{1} {R}_{1} {C}_{4} {R}_{5}} )} ] \qquad Equation ( 1 )$$

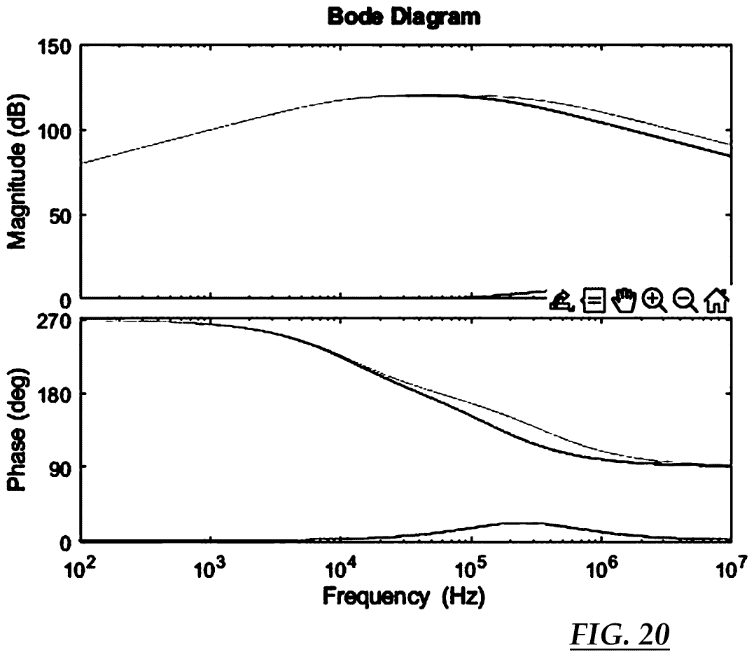

With the component values selected in the schematic, this gives us a bandpass filter with the frequency response shown in FIG. 20.

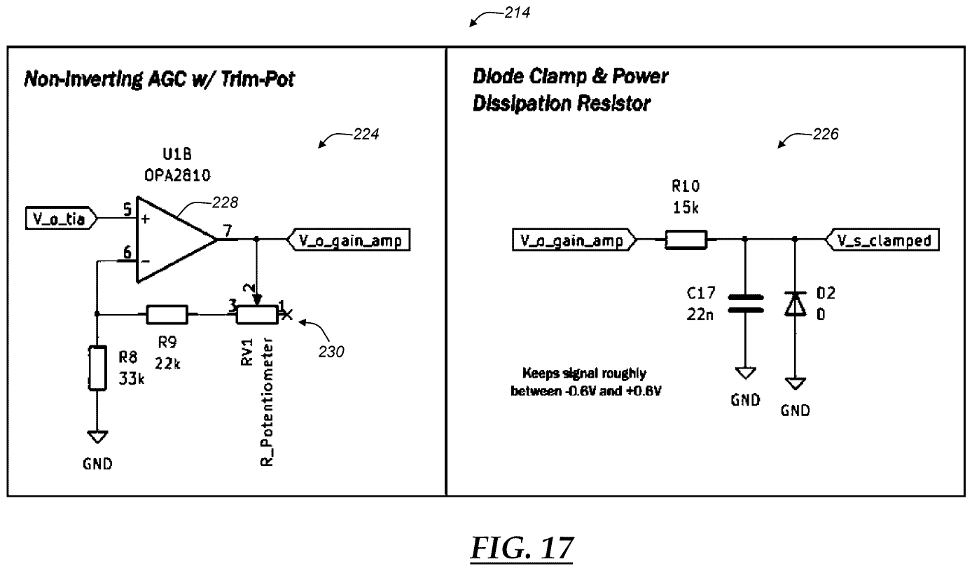

Referring back to FIG. 13, after processing by the transimpedance op-amp analog circuitry 212, the signal is fed into gain control circuitry 214, which includes a non-inverting op-amp circuit 224 and a diode clamp and power dissipation circuit 226. The non-inverting op-amp circuit 224 includes a non-inverting op-amp 228 that can be implemented with or without automatic gain control (AGC) and also includes a trim plot adjustable resistor 230 (implemented as a trim potentiometer). This is shown in FIG. 17 and can be done using an OPA2810 op-amp. Furthermore, in the present embodiment, the trim potentiometer 230 is used to set the desired amplification and maximum voltage range. The gain control circuitry 214 is configured for generating an analog gain control signal that is used for adjusting gain of the bandpass-filtered signal output by the transimpedance op-amp circuitry 212. This op-amp output (or is fed into the diode clamp and power dissipation circuit 226 to keep the signal between approximately −0.6 and 0.6 volts. This signal output by the diode clamp and power dissipation circuit 226 is referred to as a clamped analog gain control signal.

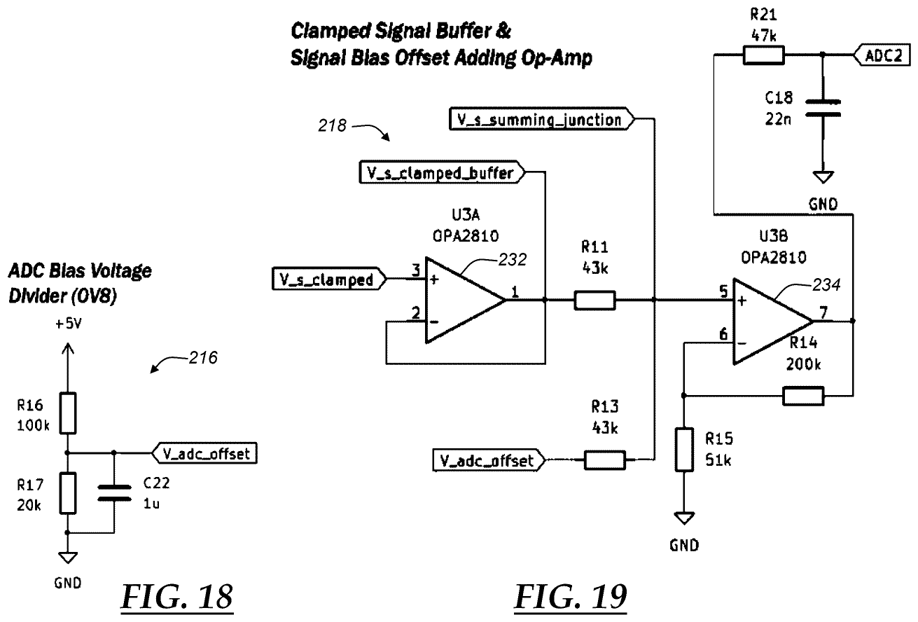

The clamped analog gain control signal is then buffered and summed with an ADC offset voltage generated using the voltage divider circuit 216 of FIG. 18. FIG. 19 depicts the voltage follower circuit 218, which is implemented using a voltage follower op-amp 232 that buffers the input signal, and it and the ADC offset are summed together at the non-inverting input of a second OPA2810 op-amp 234 having feedback to its inverting input. That final analog output (also referred to as an analog circuit output signal) is then provided via a current limiting resistor to the FPGA ADC input.

The digital signal processing device 204 is a FPGA in the present embodiment; however, according to other embodiments, the digital signal processing device 204 is an ASIC or other processing device or electronic data processor. According to embodiments, any one or more of the processors discussed herein, including each of the at least one digital signal processing device 204, is an electronic processor that may be implemented as any suitable electronic hardware that is capable of processing computer instructions and may be selected based on the application in which it is to be used. Examples of types of processors that may be used include central processing units (CPUs), graphics processing units (GPUs), field-programmable gate arrays (FPGAs), application specific integrated circuits (ASICs), microprocessors, microcontrollers, etc. Any one or more of the non-transitory, computer-readable memory discussed herein, including the memory of the digital signal processing device 204, may be implemented as any suitable type of memory that is capable of storing data or information in a non-volatile manner and in an electronic form so that the stored data or information is consumable by the processor. The memory discussed herein is computer-readable memory, may be any of a variety of different electronic memory types, and may be selected based on the application in which it is to be used. Examples of types of memory that may be used include magnetic or optical disc drives, ROM (read-only memory), solid-state drives (SSDs) (including other solid-state storage such as solid state hybrid drives (SSHDs)), other types of flash memory, hard disk drives (HDDs), non-volatile random access memory (NVRAM), etc.

With reference back to FIG. 12, the digital signal processing device 204 includes an ADC 236 for generating a sampled data signal based on the analog circuit output signal; an automatic gain control (AGC) module 238 for generating a digital gain control signal based on the sampled data signal and using a sequential propagation state machine; and a clock data recovery (CDR) module 240 having a clock recovery module 242 for generating a recovered clock output based on the digital gain control signal and also having a data decoder module 244 for decoding data within the sampled data signal based on the recovered clock output.

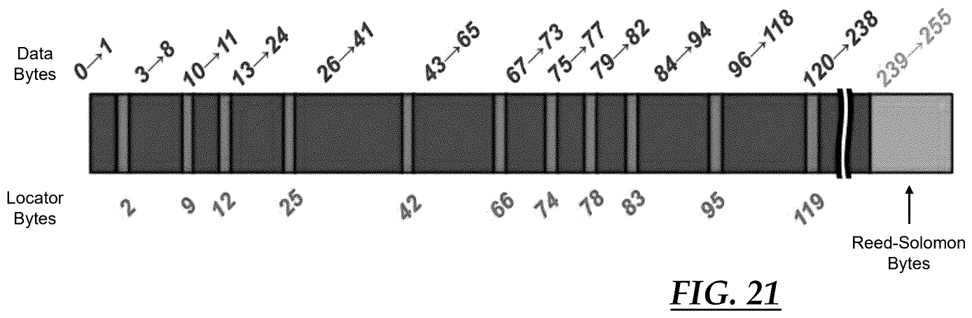

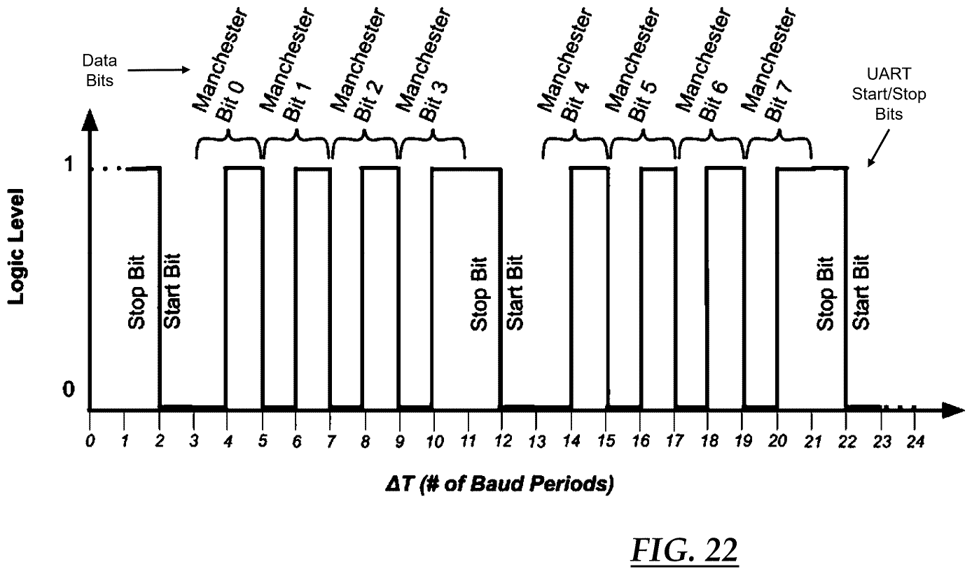

Turning to FIGS. 21 and 22, the transmission encoding scheme (protocol) used by the transmitter 41 and receiver 42 will now be described.

According to the present embodiment, each packet sent over the VLC network consists of 228 data bytes, 16 Reed-Solomon Error Correction bytes, and 11 “locator” bytes, for a total packet length of 255 bytes. This gives a Reed-Solomon notation RS(255,239). Locator bytes are static predetermined bytes situated throughout the packet that allows the receiver to know when a packet has been fully received. The locator bytes are positioned at the following indices with the values in Table 1:

TABLE 1

| Locator Byte Index | Locator Byte Value (Hexadecimal) |
|---|---|
| 2 | 0xF0 |
| 9 | 0x70 |
| 12 | 0x0C |
| 25 | 0x3D |
| 42 | 0xE8 |
| 66 | 0x90 |
| 74 | 0xF0 |
| 78 | 0xC7 |
| 83 | 0xB8 |
| 95 | 0xB2 |
| 119 | 0xF7 |

FIG. 21 shows the packet level diagram for this table, along with the Reed-Solomon bytes at the end of the packet.

In the present embodiment, the data signal is Manchester Encoded and utilizes the dedicated Universal Asynchronous Receiver/Transmitter (UART) hardware of the STM32F103 microcontroller; therefore, the present encoding scheme must adhere to the constraints of UART protocol. In the present embodiment, the transmission scheme features a baud period for the start bit, 8 baud periods for the data, and a baud period for the stop bit, giving a frame a total of 10 baud periods.

Because, in the present embodiment, the data is Manchester Encoded, each data bit sent takes two baud periods to be transmitted. In this embodiment, therefore, in order to send a single byte of data, two UART bytes are required. FIG. 22 shows the structure of a single data byte.

The bit rate of the VLC system, in this case meaning the amount of data bits transmitted as a function of baud periods elapsed, can be calculated. For this calculation, the Reed-Solomon CRC bytes, locator bytes, and UART start/stop bits are not considered data bits, and are instead considered part of the packet overhead.

Each transmitted byte taking 20 baud periods (see FIG. 22), giving a bit rate of 8/20=0.4. Of the 255 total bytes in the package, 11 are locator bytes and 16 are Reed-Solomon Error Correction bytes. This gives 255−(11+16)=228 transmitted data bytes per packet. In total, this gives a bit rate of 0.4(²²⁸/₂₅₅)=0.358. This means that if the baud rate is 57.6 kbps, the total data rate would be 57600·0.358=20600 data bits per second.

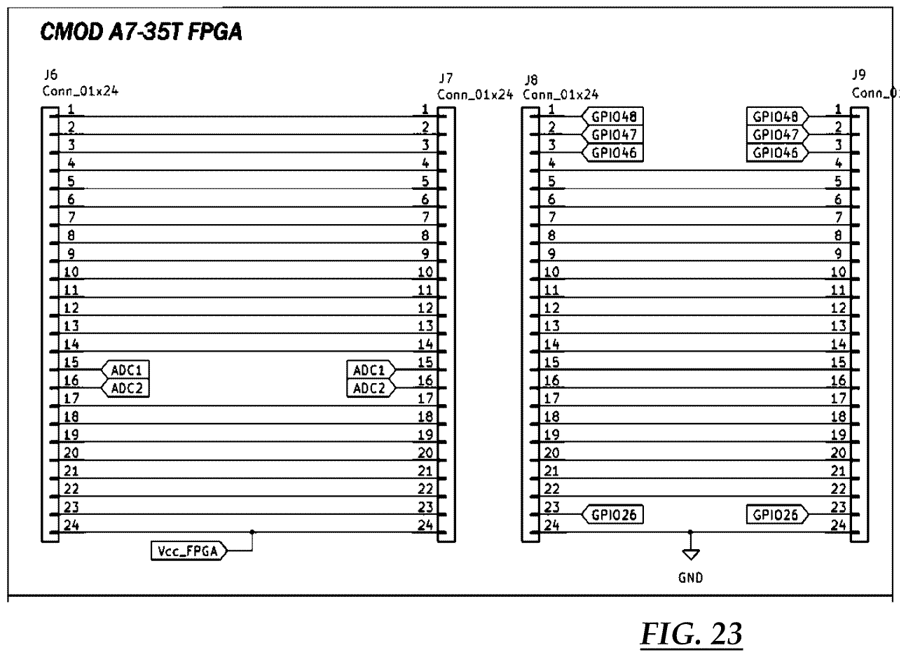

FIG. 23 shows the above-noted CMOD A7-35T development board for the programmed FPGA used to carry out the ADC and digital functions that will be described below. In the present embodiment, the FPGA includes the following modules:
XADC (Xilinx ADC IP) as the ADC 236;
AGC/CDR State Machine for the AGC module 238 and the CDR module 240;
UART Manchester Decoder;
Reed-Solomon State Machine; and
MicroBlaze Soft Processor.

The XADC is the Xilinx Vivado IP that allows sampling from the SoC's integrated ADC. According to the present embodiment, in order to sample at the maximum sampling rate (1 MSPS), the XADC block must be fed a clock frequency that is a multiple of 26 MHz and between 104 and 250 MHz. For this reason, in the present embodiment, the clock frequency is ran at 156 MHz. In the present embodiment, to bypass timing constraint errors associated with clock-domain crossing (CDC), all custom programmable logic code is also clocked at 156 MHz.

In the present embodiment, the XADC IP Block is configured to sample a single unipolar (0V to 3V3) channel in continuous mode at 1 MSPS. The analog signal is sampled through ADC channel 12. Some peripheral functionality is enabled, such as DC offset and gain calibration.

According to the present embodiment, the channel 12 positive and negative auxiliary ports of the IP Block (vauxp12 and, vauxn12 respectively) are pinned out to the top-level of the block diagram, and assigned to the corresponding pin in the physical constraints file of the project. Input and output data to the IP Block are fed via a Dynamic Reconfigure Port (DRP), a standard common to many Vivado IP along with AXI4-Lite. Through the DRP, the 7-bit address for ADC channel 12 is specified (address=x“1C”). The end-of-conversion output pin, eoc_out, is fed back to the channel enable pin den_en. This restarts the ADC conversion process as soon as it ends. Furthermore, the eoc_out port is connected to the input_valid_i port of the AGC/CDR state machine, meaning the state machine process begins each time a new sample is taken.

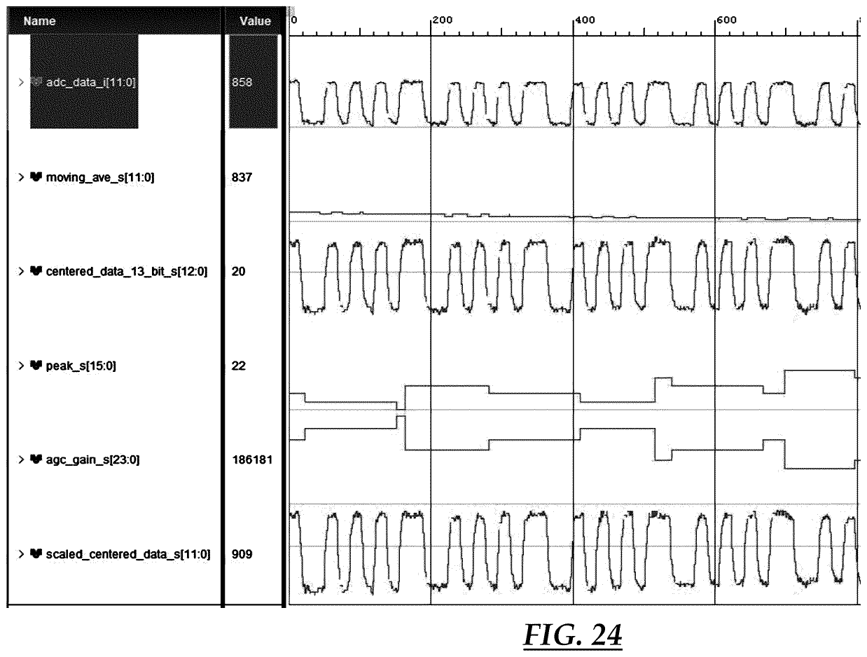

The AGC module 238 and the CDR module 240 process each new sample through a sequential state machine. The state machine waits for the end_of_conversion (EOC) output pin of the XADC block to go HIGH, signifying a new ADC sample, before beginning. Once a new sample is received, the state machine enables the AGC module 238 and waits for the AGC process to complete. The scaled and zero-centered waveform from the AGC module 238 is then passed to the CDR module 240, which is enabled to process the most recent sample. Once completed, the recovered clock and the most recent bit is output from the state machine. Sample waveforms from the AGC state machine according to the present embodiment are shown in FIG. 24.

TABLE 2

| State | Description | Δt (Clock Periods) |
|---|---|---|
| IDLE | Waits for input_valid signal to go high | Variable |
| WRITE AGC | Writes most recent sample to the AGC | 1 |
| WAIT AGC | Waits for valid output from AGC | 37 |
| INIT_CDR_VALS | Single clock period delay | 1 |
| | allowing input buff registers | |
| WRITE_CDR | Initializes and starts CDR state machine | 1 |
| WAIT_CDR | Waits for CDR state machine | — |
| | [symbol] | |
| Total: | — | — |

[symbol]

indicates data missing or illegible when filed

The AGC module 238 includes: a signal centering module for generating the digital gain control signal based on the sampled data signal; and a gain control scaling module for generating a scaled digital gain control signal based on the digital gain control signal. The signal centering module generates a centered sampled waveform by filtering the sampled data signal with a moving average filter to get a DC average and subtracting the DV average from each sample to get a digital gain control signal also referred to as a (zero-) centered data signal. The gain control scaling module generates a scaled digital gain control signal based on the digital gain control signal output by the signal centering module. The gain control scaling module generates the scaled digital gain control signal by determining a sample peak value by detecting a peak of the centered data signal using a digital peak detector circuit/module, detecting a scaling gain factor by dividing a peak reference value by the sampled peak value, and applying scaling according to the scaling gain factor to the centered data signal.

In the present embodiment, the AGC module 238 centers the sampled waveform on zero (using the signal centering module), then scales the data by a factor determined by a reference peak-to-peak value (using the gain control scaling module). The zero-centering is accomplished by filtering the waveform with a moving average filter to get the digital equivalent of the DC Average, then subtracting the DC average from each sample. Once the data is zero-centered, the peak of the waveform is detected with a digital approximation of a peak detector circuit. A peak reference value is then divided by the sampled peak value to get a scaling gain factor, which is multiplied by the zero-centered data.

The AGC process described above is accomplished with a sequential propagation state machine, which means that a state machine initializes each step, waits for valid output, and then moves onto the next process. Each state, its description, and the time to perform its corresponding action are outlined in Table 3.

TABLE 3

| State | Description | Δt (Clock Periods) |
|---|---|---|
| IDLE | Waits for input_valid | Variable |
| | signal to go high | |
| AGC_WAIT_{—} | Waits for valid output from the | 3 |
| MOVING_AVERAGE | moving average filter | |
| AGC_ZERO_{—} | Subtracts the moving average | 1 |
| CENTER_SUBTRACT | from incoming waveform. | |
| | Also, increments | |
| | peak_detector_count_s, which is | |
| | used in the peak detector's | |
| | decay. | |
| AGC_ZERO_{—} | Delay the subtract operation for | 1 |
| CENTER_SUBTRACT_D1 | timing closure purposes, and for | |
| | unsigned to | |
| | signed type conversion. | |
| AGC_ZERO_{—} | Delay the subtract operation for | 1 |
| CENTER_SUBTRACT_D2 | timing closure purposes, and for | |
| | unsigned to | |
| | signed type conversion. | |
| AGC_PEAK_{—} | Determines whether peak s | 1 |
| DETECTOR_CALC_{—} | register needs to be updated, due | |
| CONDITIONALS | to a new peak value being | |
| | detected or enough time elapsing | |
| | to elicit decay. | |
| AGC_PEAK_{—} | Writes new peak value to | 1 |
| DETECTOR_WRITE_{—} | peak_temp_s | |
| TEMP_PEAK | | |
| AGC_PEAK_{—} | Writes peak_temp_s | 1 |
| [symbol] | [symbol] | |
| AGC_START_{—} | Start the Divider Generator | 1 |
| [symbol] | [symbol] | |
| AGC_WAIT_{—} | Waits for Divider to | 26 |
| [symbol] | [symbol] | |
| AGC_MULTIPLY_{—} | Multiplies the register holding | 1 |
| GAIN | the zero-centered data sample | |
| | by the AGC gain value. Also, | |
| | toggles the output valid o | |
| | [symbol] | |
| Total: | — | 37 |

[symbol]

indicates data missing or illegible when filed

Some real-time signal waveforms pertaining to the AGC system were capture with an Integrated Logic Analyser are shown below.
adc_data_s: 12 bit unsigned. The sampled incoming data from the XADC. In this example, the waveform has a crest at approximately 850 and a trough at approximately 810.
moving_ave_s: 12 bit unsigned. The moving average of adc_data_s.
centered_data_13_bit_s: see Table 4.

TABLE 4

| Signal | Radix | Description |
|---|---|---|
| adc_data_s | 12 bit unsigned | The sampled incoming data from the |
| | | XADC. In this example, the |
| | | waveform has a crest at |
| | | approximately 850 and a trough at |
| | | approximately 810. |
| moving_ave_s | 12 bit unsigned | The moving average |
| | | of adc [symbol] data [symbol] s [symbol] |
| centered_data_{—} | 13 bit signed | The waveform from adc_data_s |
| 13_bit_s | | centered around zero. Derived |
| | | by subtracting |
| | | adc_data_s − moving_ave_s. |
| peak_s | 16 bit unsigned | The local maximum of |
| | | centered_data, this signal decays |
| | | over time [symbol] |
| agc_gain_s | 24 bit unsigned fixed-point | The gain value that is multiplied with |
| | with 12 integer bits and 12 | centered_data_s. Derived by dividing |
| | fractional bits | target peak-to-peak reference (1000 |
| | | in this case) by peak_s. |
| scaled_centered_{—} | 12 bit signed | Output of AGC. Waveform has |
| data_s | | crest at approximately 1000 and |
| | | trough at approximately −1000. |

[symbol]

indicates data missing or illegible when filed

The CDR module 240 includes a clock recovery (CR) module 242 and a data decoder module 244. The CR module 242 is used for generating a recovered clock output based on the (scaled) digital gain control signal. The data decoder module 244 is used for determining the data encoded in the light signal received at the receiver 42 through use of the recovered clock output from the CR module 242.

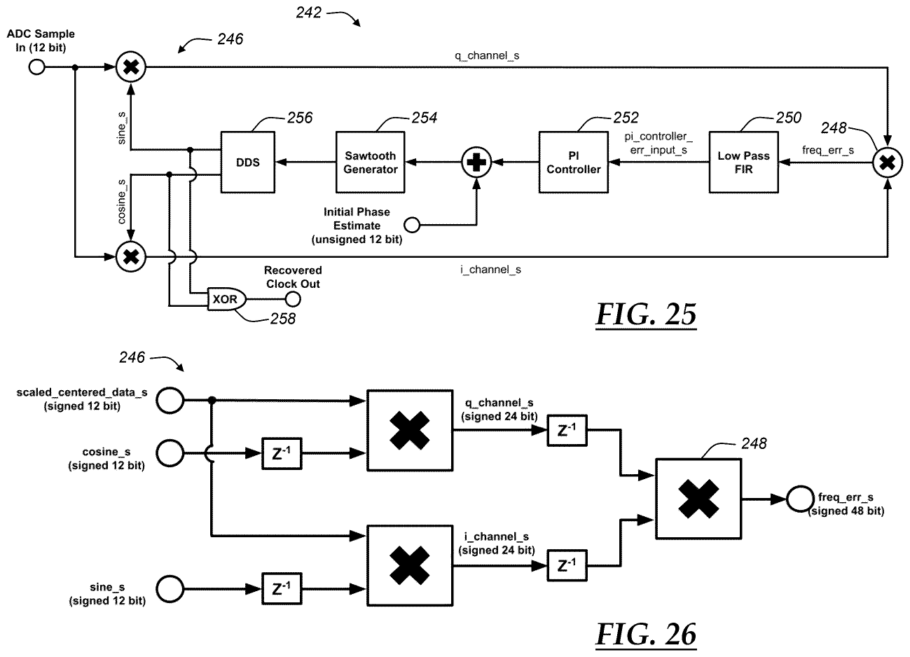

FIG. 25 shows a block diagram of the CR module 242 of the FPGA (the digital signal processing device 204 of the present embodiment). According to embodiments, the CR module 242 includes: a quadrature signal conditioning module 246; a signal multiplier 248; a low-pass Finite Impulse Response (FIR) filter 250; a proportional integral (PI) controller (PI-controller) 252; a sawtooth generator (or arithmetic accumulator) 254; a direct digital synthesizer (DDS) 256; and an exclusive or (XOR) module 258. The quadrature signal conditioning module 246 is used for generating an in-phase (I) signal and a quadrature (Q) signal based on the (scaled) digital gain control signal and sinusoidal waveforms generated by the DDS 256. The signal multiplier 248 is used for generating a phase error signal based on the I signal and the Q signal. The low-pass FIR filter 250 is used for reducing/attenuating high-frequency signals within the phase error signal to generate a filtered phase error signal. The PI-controller 252 is used for generating a timing control signal based on the (filtered) phase error signal. The sawtooth generator 254 is used for generating a phase accumulator output based on the timing control signal and an initial phase estimate. The DDS 256 is used for generating sinusoidal waveforms (a pair comprised of a sine waveform and a cosine waveform) based on the phase accumulator output. The XOR module 258 is used for generating a recovered clock output based on the sinusoidal waveforms.

The CDR state machine is based off a Costa's Loop topology for binary phase shift keyed (BPSK) signals. Once the ADC output waveform is centered and scaled by the AGC state machine, the waveform is split and multiplied by two sinusoidal waveforms 90° out of phase with each other to produce in-phase (I-Channel) and quadrature (Q-Channel) signals. The I-Channel and Q-Channel are multiplied together at the signal multiplier 248 to produce a phase error signal, which is then filtered by the low-pass FIR filter 250 and fed into the PI-controller 252. The PI-controller output is added with an initial phase-step “estimate value,” which is summed with the arithmetic accumulator 254 to produce a roll-over sawtooth signal (also referred to as a phase accumulator output). The slope of this sawtooth signal is what is modulated by the PI-controller 252, and corresponds to the recovered clock frequency. This sawtooth signal is fed into a Vivado Direct Digital Synthesizer (DDS) IP Core (the DDS 256), and the resulting sine and cosine waveforms generated are XOR-ed together (using the XOR module 258) to produce the recovered clock signal. The sine and cosine are also the two sinusoidal waveforms 90° out of phase with each other, which are mixed with the incoming data, closing the feedback loop.

According to the present embodiment, the purpose of the CR module 242 is to generate a sine and cosine wave with the same frequency (referred to as the “estimated frequency”) which is close in frequency to the incoming data, then determine the frequency error between the estimated frequency and frequency of the incoming data. According to embodiments, although the sampled incoming waveform is ideally a square wave, the clock can be recovered by regarding the waveform as a BPSK sinusoidal. Treating it as a sinusoidal, the incoming waveform will have the formula sin(2πfᵢₙt), where fᵢₙ, is the frequency of the incoming data. The waveforms generated with the estimated frequency have the equations sin(2πfₑₛₜt) and cos(2πfₑₛₜt). The frequency error is derived as explained below in connection with the channel mixing and the low-pass FIR filter 250.

### I-Channel Mixing Arithmetic

As the incoming data is multiplied by a cosine wave with the estimated frequency of fₑₛₜ, the following equation is derived and simplified.

$$\begin{matrix}sin ( 2 π {f}_{in} t ) \cdot cos ( 2 π {f}_{est} t ) \\ Substituting e = 2 π {f}_{est} t and i = 2 π {f}_{in} t :\end{matrix} \qquad Equation ( 2 )$$

$$sin ( i ) \cdot cos ( e ) = \frac{1}{2} [ sin ( i + e ) + sin ( i - e ) \qquad Equation ( 3 )$$

### Q-Channel Mixing Arithmetic

As the incoming data is multiplied by a sine wave with the estimated frequency of fₑₛₜ, the following equation is derived and simplified.

$$\begin{matrix}sin ( 2 π {f}_{in} t ) \cdot sin ( 2 π {f}_{est} t ) \\ Substituting e = 2 π {f}_{est} t and i = 2 π {f}_{in} t :\end{matrix} \qquad Equation ( 4 )$$

$$sin ( i ) \cdot sin ( e ) = \frac{1}{2} [ cos ( i - e ) - cos ( i + e ) ] \qquad Equation ( 5 )$$

### I-Channel and Q-Channel Mixing Arithmetic

When the I-Channel and Q-Channel are multiplied together, the following equation is derived and simplified:

$$\begin{matrix}\frac{1}{4} [ ( sin ( i + e ) + sin ( i - e ) ) \cdot ( cos ( i - e ) - cos ( i + e ) ) ] \\ Substituting i + e = α and i - e = β and expanding :\end{matrix} \qquad Equation ( 6 )$$

$$\frac{1}{4} [ sin ( α ) cos ( β ) - sin ( α ) cos ( α ) + sin ( β ) cos ( β ) - sin ( β ) cos ( α ) ] \qquad Equation ( 7 )$$

It is important to note here that the main purpose is to isolate the frequency difference (a.k.a. β=i−e). For example, if the estimated frequency is fₑₛₜ=100 kHz but the incoming data signal is arriving at fᵢₙ=101 kHz, then β=fᵢₙ−fₑₛₜ=101 kHz−100 kHz=1 kHz. Using Angle-Sum Identity, sin(α−β)=sin(α) cos(β)−cos(α) sin(β):

$$= \frac{1}{4} [ sin ( α - β ) - sin ( α ) cos ( α ) + sin ( β ) cos ( β ) ] \qquad Equation ( 8 )$$

Finally, with the Product Identity

$$sin ( α ) cos ( β ) = \frac{1}{2} [ sin ( α + β ) + sin ( α - β ) ] ,$$

the equation simplifies to:

$$= \frac{1}{4} [ sin ( α - β ) - \frac{1}{2} sin ( 2 α ) + \frac{1}{2} sin ( 2 β ) ] \qquad Equation ( 9 )$$

The reduced equation can be separated into three terms: (1.) sin(α−β); (2.) ½sin(2α); and (3.) ½sin(2β).

In the previous example described where fₑₛₜ=100 kHz and fᵢₙ=101 kHz, α=201 kHz and β=1 kHz. The first term is a sinusoidal with frequency of 100 kHz, the second term is a sinusoidal with frequency of 402 kHz, and the third term is a sinusoidal with frequency of 2 kHz. As we have isolated β in the third term, the low-pass FIR filter 250 can be used to attenuate the first two terms. The isolated third term is a sinusoidal that represents the phase difference between the estimated frequency and the frequency of the actual data. This is fed into the PI-controller 252, which controls the estimates' frequency and drives the frequency error to zero.

Mixing the incoming data with two sinusoidal waveforms 90° out of phase with each other is achieved with three Vivado Multiplier IP blocks cascaded as shown in FIG. 26. The resulting signal freq_err_s is a signed 48-bit integer. Note that the delay blocks in the diagram below are for FPGA meta-stability purposes to close failing timing endpoints. The delays are handled by the wrapper state machine.

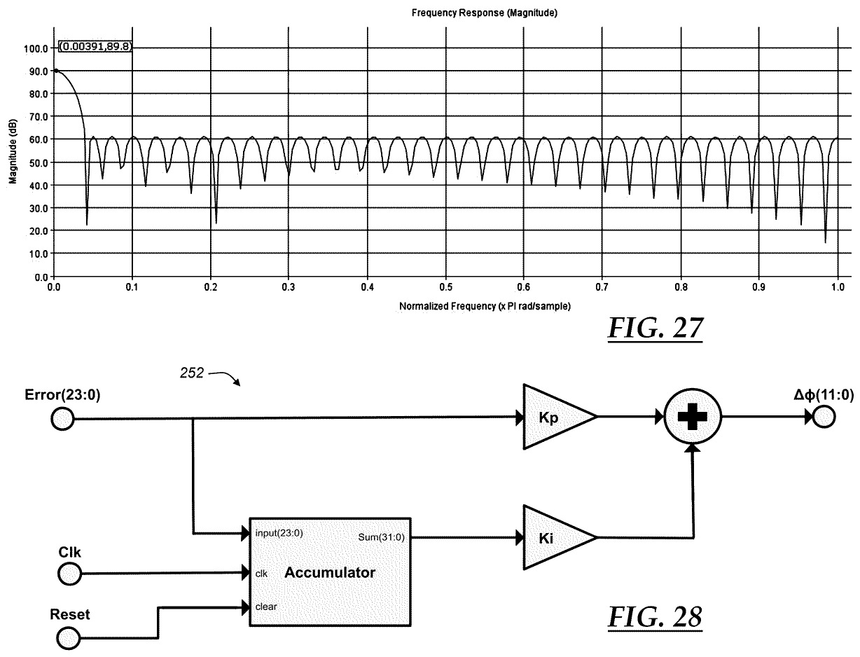

According to the present embodiment, in order to extract the phase difference from the freq_err_s signal in FIG. 27, a FIR low-pass filter (LPF) (which is the low-pass FIR filter 250 in the present embodiment). Vivado™ provides an FIR Compiler IP, which allows a user to specify the filter coefficients, and the IP will properly pipeline the filter and implement DSP blocks where necessary. This filter is designed as a 65-order filter with a −3 dB cut-off frequency of f_{c}=9.7 kHz, and an output that is a 40 bit signed integer. It has a sample latency of 33 cycles, after which it toggles the m_axis_data_tvalid output. This filter is used by writing a single sample, enabling the filter, waiting for m_axis_data_tvalid to go high, then disabling the filter until the next sample is ready to be processed.

The filtered phase difference signal pi_controller_err_input_s is then fed into the PI-controller 252 shown in FIG. 28. The PI-controller 252 is accomplished in 3 clock cycles with 3 states in the state machine. The first state calculates the proportional branch by multiplying the error input by Kₚ, and adds the error input to an accumulator (a.k.a. integrator) for the integral branch. The second state multiplies the accumulator by Kᵢ by the accumulator value to calculate the value of the integral branch. The final branch calculates the PI-controller output by adding the values of the proportional and integral branches. In the present embodiment, the output is sliced into a 12 bit signed integer, which is necessary to eventually be fed into the DDS 256.

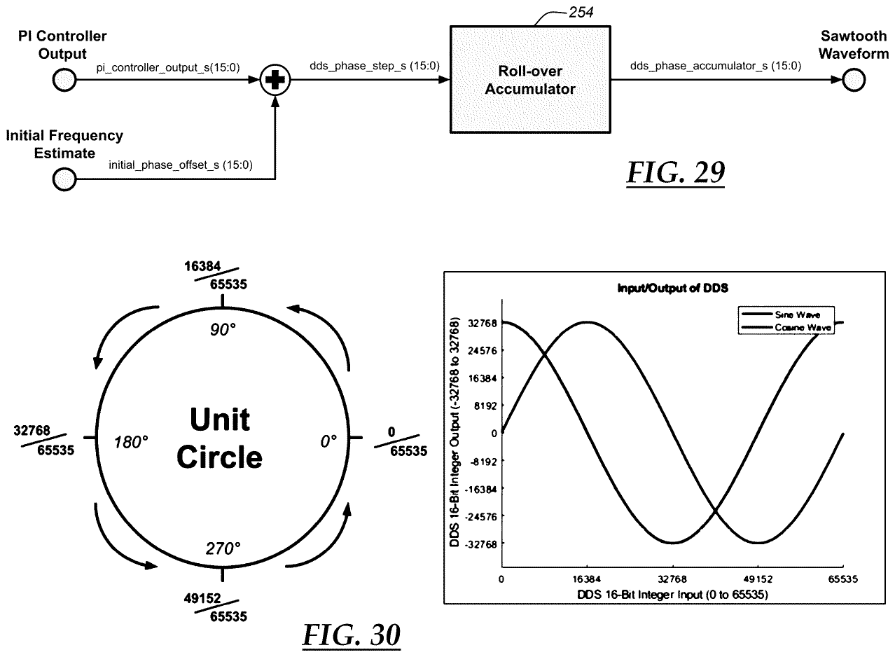

Referring to FIG. 29, in the present embodiment, the sawtooth phase generator 254 is used to control the frequency of the sine and cosine waveforms generated by the DDS 256. To achieve this, an initial frequency estimate is tuned to match the frequency of the incoming data waveform. For example, if the incoming data has a frequency of approximately 50 kHz and the sampling rate is 1 MSPS, each received bit will have 20 samples per bit as shown below:

$$\frac{1 , 000 , 000 \frac{samples}{sec}}{50 , 000 \frac{bits}{sec}} = 20 samples per bit \qquad Equation ( 10 )$$

Because the DDS 256 of the present embodiment has 65,536 positions around the unit circle, generating an initial frequency estimate of 50 kHz would require the initial_phase_offset_s signal to be (65536/20)=3277. As the phase difference between the generated signal and the actual incoming data signal is fed into the PI-controller 252, the phase difference is summed with the initial_phase_offset_s signal to get the phase of the corrected signal. This is then added to a 16 bit accumulator, designed to rollover past 65536 (meaning once per period of a received bit). The instantaneous value of the accumulator is the instantaneous phase of the recovered clock, and the rate of change of the accumulator (the number that is added to the accumulator each sample) is the frequency.

At least in the present embodiment, the DDS 256 is a lookup table capable of simultaneously generating sine and cosine wave-forms. Because the DDS 256 accepts a 16 bit unsigned integer as a phase input, it is capable of generating 2¹⁶=65536 positions around the unit circle, as shown in FIG. 30.

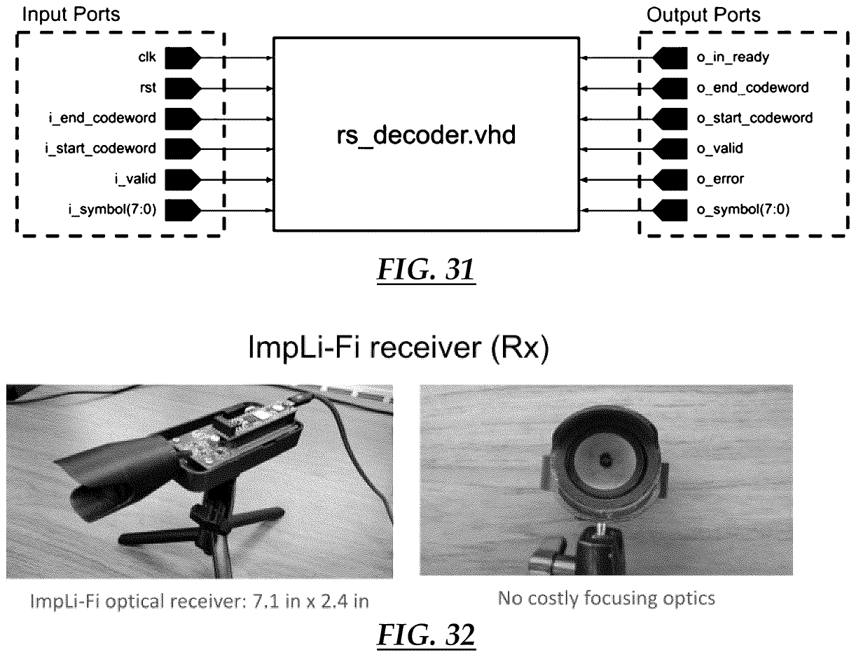

The Reed-Solomon State Machine is based on the RS Codec Core. The main VHDL (Very High-Speed Integrated Circuit (VHSIC) Hardware Description Language) component of the core is found in the rs_decoder.vhd file, with IO ports corresponding to the following diagram. The parameters of the Reed-Solomon system (which in this case are RS(255,239)) are set as generics in the VHDL file. FIG. 31 is a block diagram of the rs_decoder.vhd.

The FPGA (the digital signal processing device 204 of the present embodiment) contains a MicroBlaze soft processor, which is mainly used to set parameter registers in the FPGA fabric and utilize the USB for printing received data to the host computer.

According to the present embodiment, when power bootup occurs, the first thing to execute in the MicroBlaze is writing values XGPIO ports, which allow for proper operation of the FPGA. A table describing the names and functions of each XGPIO are outlined in Table 5.

TABLE 5

| XGPIO Name | IO | Description |
|---|---|---|
| write_kp | O | Sets the proportional gain constant for the PI |
| | | controller in the CDR |
| write_ki_s | O | Sets the integral gain |
| | | constant for the PI controller in the CDR |
| write_detect_{—} | O | Prior version of the Receiver used level |
| threshold | | binning to determine if a signal was begin |
| | | received. No longer in use. |
| write_cdr_init_{—} | O | Sets the initial frequency of recovery clock. |
| val | | It serves as an estimate close to the actual |
| | | clock of the received data, and is modified |
| | | by the CDR block to match the frequency. |
| read_msg_count | I | The FPGA counts how many packets have |
| | | been received. This value is printed in |
| | | debugging mode. |
| read_dds_phase_{—} | I | The phase step of the sawtooth generator |
| step | | correlates to the frequency of the recovered |
| | | clock. This value is printed in debugging |
| | | mode. |
| read_adc_data | I | The unsigned 12 bit integer that is received |
| | | directly from the ADC. Is printed in |
| | | debugging mode. |

In the present embodiment, when the FPGA state-machine detects and successfully decodes a packet, it writes the received string to memory mapped JO that the MicroBlaze soft-processor is able to access with the decoded_data_mem_map_ptr pointer. When this occurs, an interrupt is thrown, allowing the MicroBlaze to know when to copy the contents of the memory mapped JO. In the interrupt handler, the FormatDecodedDatao function breaks the memory from 32-bit binary values to byte-sized ASCII chars for printing. The ASCII chars are then printed to the USB with the xil_printf( ) function. Finally, the interrupt flag is cleared and the interrupt handler is exited, allowing the interrupt to be repeated when the next packet is received.

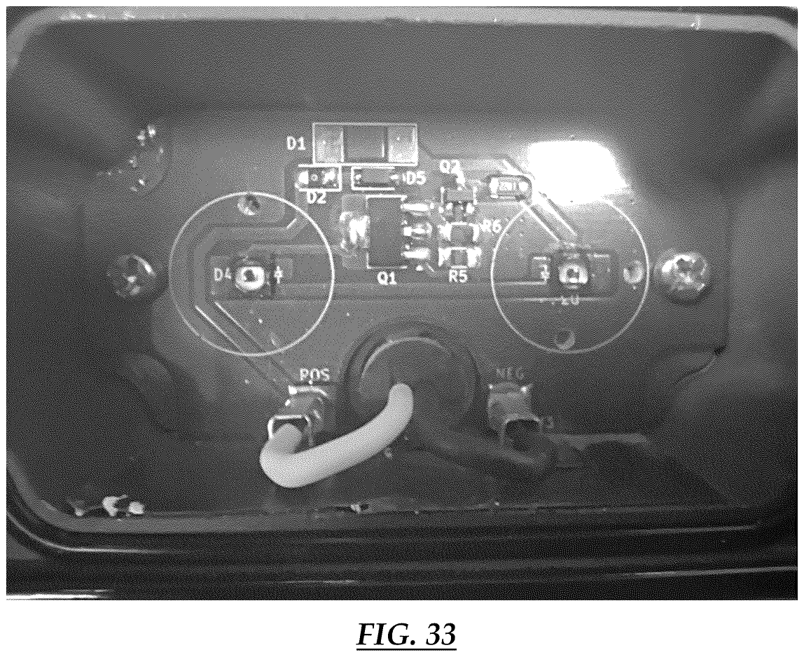

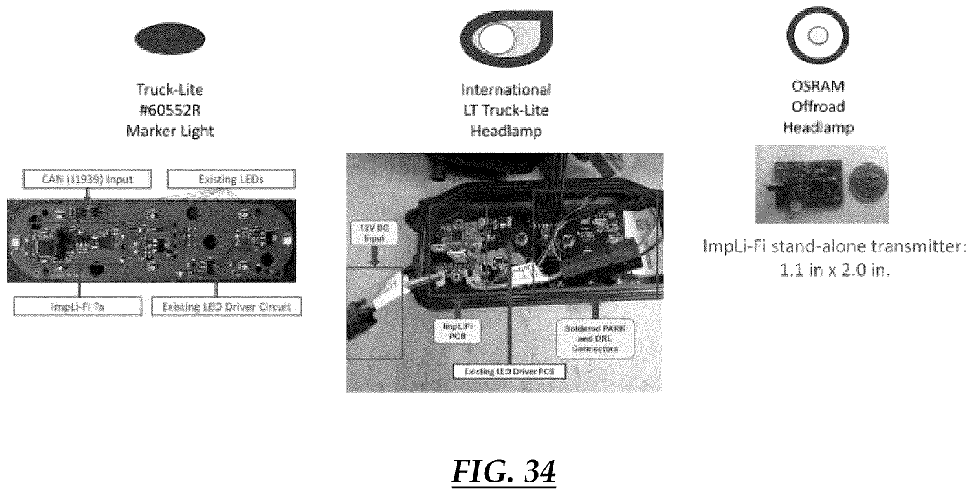

FIGS. 32 and 33 show prototype implementations of the receiver 42 and transmitter 41, respectively. FIG. 34 shows various commercially-available vehicle exterior lamp modules modified to include the transmitter 41.

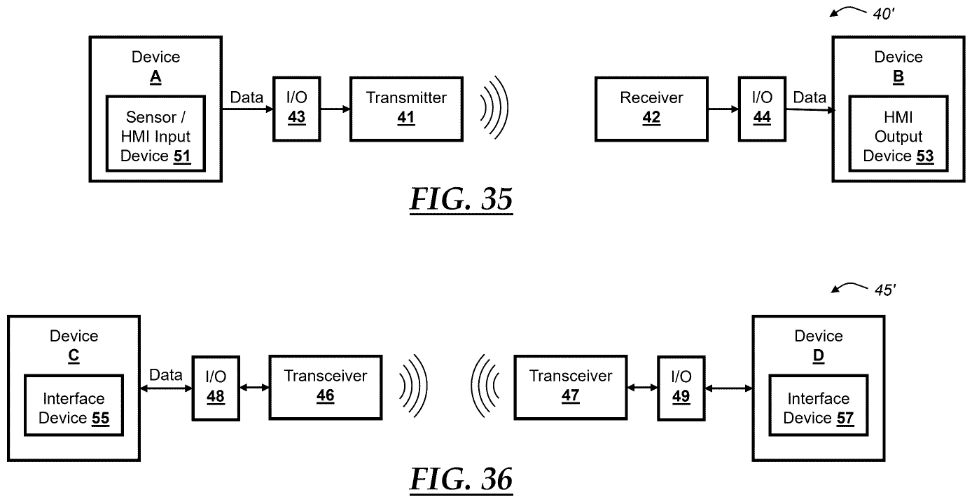

FIG. 35 depicts a light communication system 40′ having the pair of electronic devices A and B that provide one way data communication from Device A to Device B as discussed above in connection with the light communication system 40 of FIG. 1, except that, in the light communication system 40′, an input interface device 51 is illustrated as being a part of the Device A and a human machine interface (HMI) output device 53 is illustrated as being a part of the Device B.

The input interface device 51 is used for receiving inputs at the Device A, such as, for example, HMI inputs and/or sensor data captured by a sensor of the Device A. Accordingly, in embodiments, the input interface device is a sensor and/or a HMI input device. A HMI input device is a HMI device that is configured to receive information from a (human) user so that the information may be encoded and transmitted by the transmitter 41. The HMI input device may be, for example, a microphone, a pushbutton, a touch screen, a keyboard, a mouse, a joystick, a camera, or any other suitable device that allows a user to provide input into the Device A. In embodiments, the input interface device 51 is a sensor, such as, for example, a camera, microphone, radar sensor, lidar sensor, accelerometer, strain gauge, vibration sensor, temperature sensor, pressure sensor, etc. For example, in one embodiment, the input interface device 51 is a camera so that image data (representing images captured by the camera) can be used to communicate pictures via the light communication system 40′.

The HMI output device 53 is a HMI device that is configured to present information to a (human) user so that the information may be interpreted by the user. The HMI output device 53 may be, for example, a display screen, a speaker, a printer, a projector, or any other suitable device that allows information to be presented to the human user in a way that can be interpreted by the user. For example, audio captured and transmitted by the transmitter 41 may be received at the receiver 42 and played by a speaker at Device B. In another example, image data captured by the input interface device 51 may be transmitted by the transmitter 41, received by the receiver 42, and presented on a display screen or projector of the Device B.

FIG. 36 depicts a light communication system 45′ having the pair of electronic devices C and D that provide bi-directional (duplex) data transfer between two electronic devices C and D as discussed above in connection with the light communication system 45 of FIG. 2, except that, in the light communication system 45′, an interface device 55 is illustrated as being a part of the Device C and an interface device 57 is illustrated as being a part of the Device D. Each of the HMI devices 55,57 may include one or both of the input interface device 51 and the HMI output device 53 discussed in connection with FIG. 35.

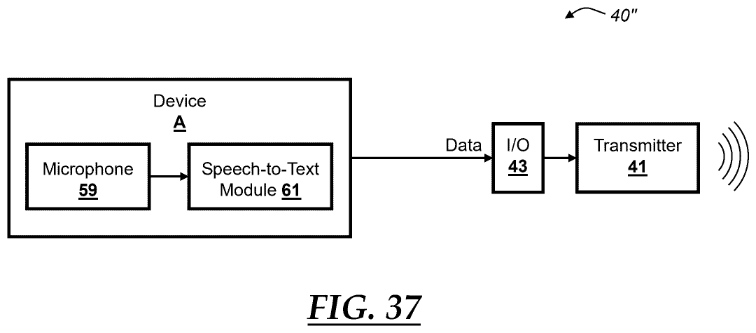

FIG. 37 depicts a transmitter portion of a light communication system 40″, which is an example of the light communication system 40′ of FIG. 35. The Device A includes a microphone 59 as the interface input device 51 used for receiving audio (sound) from the human user and also includes a speech-to-text module 61 for converting the audio signal from the microphone 59 to a suitable digital electronic format for use in encoding the audio for transmission by the transmitter 41. The speech-to-text module 61 may employ various algorithms and techniques, such as natural language processing (NLP) and machine learning models, to accurately transcribe spoken words into text (e.g., into American Standard Code for Information Interchange (ASCII) characters). For example, the module could utilize deep learning networks like recurrent neural networks (RNNs) or transformer models to enhance accuracy and context understanding. Additionally, the speech-to-text module 61 may support multiple languages and dialects, allowing for broader user interaction. Specific examples of the speech-to-text processing include applications such as voice-activated virtual assistants, automated transcription services for meetings or lectures, and voice-controlled smart home devices. These applications demonstrate the versatility and utility of integrating a speech-to-text module in Device A, providing seamless interaction and functionality for the user. According to embodiments, each or both of the interface devices 55,57 of the light communication system 45′ include the microphone 59 and/or the speech-to-text module 61. In embodiments, the Device A of the light communication system 40″ may omit the speech-to-text module 61 and instead encode the audio signal from the microphone 59 so that the audio itself may be presented by the HMI output device 53 for audio playback of the audio signal captured by the microphone (as opposed to, for example, presenting text or generating new audio based on the text output from the speech-to-text module 61).

According to embodiments, the light communication systems described herein (including one or more of the systems 40,40′,40″,45,45′) may be used for: performing highly secure wireless software updates, of vehicles, machines, weapons, buildings, infrastructure; a variety of covert/special-military operations including for information drops; SOS transmission device including in urban/remote/underground/underwater/Bekow-Rubbell search and rescue situations; an entry/exit security applications (for authenticating/authorizing entry, exit, and/or access of a building or compartment); and/or financial transactions.

According to embodiments, the light communication systems described herein (including one or more of the systems 40,40′,40″,45,45′) may include an adjustable lens in the front end, it can communicate to multiple receivers with a fan beam (short focal length lens) or it can communicate to a specific receiver with a narrow beam (long focal length lens).

It is to be understood that the foregoing description is of one or more embodiments of the invention. The invention is not limited to the particular embodiment(s) disclosed herein, but rather is defined solely by the claims below. Furthermore, the statements contained in the foregoing description relate to the disclosed embodiment(s) and are not to be construed as limitations on the scope of the invention or on the definition of terms used in the claims, except where a term or phrase is expressly defined above. Various other embodiments and various changes and modifications to the disclosed embodiment(s) will become apparent to those skilled in the art.

As used in this specification and claims, the terms “e.g.,” “for example,” “for instance,” “such as,” and “like,” and the verbs “comprising,” “having,” “including,” and their other verb forms, when used in conjunction with a listing of one or more components or other items, are each to be construed as open-ended, meaning that the listing is not to be considered as excluding other, additional components or items. Other terms are to be construed using their broadest reasonable meaning unless they are used in a context that requires a different interpretation. In addition, the term “and/or” is to be construed as an inclusive OR. Therefore, for example, the phrase “A, B, and/or C” is to be interpreted as covering all of the following: “A”; “B”; “C”; “A and B”; “A and C”; “B and C”; and “A, B, and C.”

1. Alight communication system, comprising:
a transmitter configured to transmit light; and
a receiver configured to determine data encoded in the light transmitted by the transmitter, wherein the receiver includes:
a light sensor for sensing the light transmitted by the transmitter;
transimpedance op-amp circuitry having a transimpedance op-amp integrator circuit and a transimpedance op-amp differentiator circuit;
a gain control circuit; and
a digital signal processing device configured to recover a clock of the incoming light and to decode the data encoded in the light using the clock.

2. The light communication system of claim 1, wherein the light sensor is a photodiode.

3. The light communication system of claim 1, wherein the transimpedance op-amp circuitry and the gain control circuit are a part of analog circuitry that generates a conditioned analog signal based on a light signal that is output from the light sensor.

4. The light communication system of claim 1, wherein the transimpedance op-amp integrator circuit is configured to generate a transimpedance integrated output signal by amplification of the sensor signal, and wherein the transimpedance op-amp differentiator circuit is configured to generate a bandpass-filtered signal based on bandpass filtering of the transimpedance integrated output signal.

5. The light communication system of claim 1, wherein the gain control circuitry is configured to generate an analog gain control signal adjusting gain of an analog signal output by the transimpedance op-amp integrator circuit.

6. The light communication system of claim 5, wherein the gain control circuitry includes a non-inverting automatic op-amp circuit having a non-inverting op-amp for generating the analog gain control signal.

7. The light communication system of claim 1, wherein the digital signal processing device is a field programmable gate array (FPGA) or an application specific integrated circuit (ASIC).

8. The light communication system of claim 1, wherein the digital signal processing device includes an analog-to-digital converter (ADC) for converting an analog signal output by the gain control circuit into a digital signal.

9. The light communication system of claim 1, wherein the digital signal processing device includes an automatic gain control (AGC) module configured to generate a digital gain control signal based on sampled data sampled based on an analog signal output by the gain control circuit.

10. The light communication system of claim 1, wherein the digital signal processing device includes a clock data recovery (CDR) module for recovering a clock of the light transmitted by the transmitter and for decoding data encoded within the light using the clock.

11. The light communication system of claim 10, wherein the CDR module includes a clock recovery (CR) module and a data decoder module, wherein the CR module is configured to recovering the clock of the light transmitted by the transmitter, and wherein the data decoder module is configured to decode the data encoded within the light using the clock.

12. The light communication system of claim 10, wherein the CDR module uses a finite-state machine (FSM) as a part of decoding the data encoded within the light using the clock.

13. The light communication system of claim 12, wherein the FSM is configured to implement an error correcting procedure using Reed-Soloman error correction or other error correction framework.

14. The light communication system of claim 1, further comprising a microphone configured to capture audio at a first device in communication with the transmitter, wherein the light transmitted by the transmitter includes encoded data representing the audio or text derived from the audio captured by the microphone.

15. Alight communication system, comprising:
a transmitter configured to transmit light; and
a receiver configured to determine data encoded in the light transmitted by the transmitter, wherein the receiver includes:
a light sensor for sensing the light transmitted by the transmitter;
analog circuitry configured to generate a conditioned analog signal based on a light signal that is output from the light sensor, wherein the conditioned analog signal is generated by conditioning the light signal through transimpedance amplification; and
a digital signal processing device configured to recover a clock of the light transmitted by the transmitter by processing the conditioned analog signal and to decode the data encoded in the light using the clock.

16. The light communication system of claim 15, wherein the conditioned analog signal is generated by conditioning the light signal through bandpass filtering.

17. The light communication system of claim 16, wherein a transimpedance op-amp differentiator circuit is used for performing the bandpass filtering through generating a bandpass-filtered signal based on a transimpedance integrated output signal output from a transimpedance op-amp integrator circuit.

18. The light communication system of claim 15, wherein the analog circuitry includes a gain control circuit for generating an analog gain control signal, and wherein the digital signal processing device includes an automatic gain control (AGC) module for generating a digital gain control signal based on the analog gain control signal.

19. Alight communication system, comprising:
a transmitter configured to transmit light; and
a receiver configured to determine data encoded in the light transmitted by the transmitter, wherein the receiver includes:
a light sensor for sensing the light transmitted by the transmitter;
analog circuitry configured to generate a conditioned analog signal based on a light signal that is output from the light sensor; and
a digital signal processing device having an automatic gain control (AGC) module and a clock recovery module, wherein the AGC module is configured to generate a gain-controlled digital signal, wherein the clock recovery module is configured to recover a clock of the incoming light, and wherein the clock of the incoming signal is used to decode the data encoded in the light.

20. The light communication system of claim 19, wherein the analog circuitry includes transimpedance op-amp circuitry for conditioning the light signal through transimpedance amplification and bandpass filtering.
